(19) United States
(12) Patent Application Publication
(10) Pub. No.: US 2021/0026375 A1
(43) Pub. Date: Jan. 28, 2021

(54) AIRCRAFT AND AIRCRAFT GUIDANCE SYSTEM

(71) Applicants: SOKEN, INC., Nisshin-city (JP); DENSO CORPORATION, Kariya-city (JP)

(72) Inventors: Satoru YOSHIKAWA, Nisshin-city (JP); Takenori MATSUE, Nisshin-city (JP); Tetsuji MITSUDA, Kariya-city (JP); Masataka HIRAI, Kariya-city (JP)

(21) Appl. No.: 17/060,414

(22) Filed: Oct. 1, 2020

Related U.S. Application Data
(63) Continuation of application No. PCT/JP2019/014969, filed on Apr. 4, 2019.

(30) Foreign Application Priority Data
Apr. 5, 2018 (JP) 2018-073171
May 11, 2018 (JP) 2018-092203

(51) Int. Cl. G05D 1/10; G08G 5/00; B64C 39/02

(52) U.S. Cl. CPC G05D 1/101; G08G 5/003; B64C 2201/146; G08G 5/0013; B64C 2201/12; B64C 39/024

(57) ABSTRACT

An aircraft includes a main body, a structure member, and a retroreflective member. The structure member is provided below the main body in a gravity direction. The retroreflective member is provided in the structure member and reflects a light, which is emitted from a ground facility, toward the ground facility.

### CROSS REFERENCE TO RELATED APPLICATIONS

The present application is a continuation application of International Patent Application No. PCT/JP2019/014969 filed on Apr. 4, 2019, which designated the U.S. and claims the benefit of priority from Japanese Patent Application No. 2018-073171 filed on Apr. 5, 2018 and Japanese Patent Application No. 2018-092203 filed on May 11, 2018. The entire disclosures of all of the above applications are incorporated herein by reference.

### TECHNICAL FIELD

The present disclosure relates to an aircraft and an aircraft guidance system.

### BACKGROUND

An aircraft so-called drone has recently become widespread. The aircraft flies mainly by wireless or wired remote control by a ground operator. When remotely controlling the aircraft in this manner, it is necessary to synchronously acquire the current position of the aircraft. Information on obstacles existing around the aircraft is acquired, and a safe flight range in which safe flight of the aircraft is ensured is set based on the acquired information. Then, the ground facility implements the guidance of the aircraft while tracking the aircraft flying in the safe flight range.

### SUMMARY

According to a first example of the present disclosure, an aircraft is provided to include a main body, a structure member, and a retroreflective member. The retroreflective member reflects the light emitted from the ground facility to the ground facility. The retroreflective member is provided in the structure member provided below (i.e., in a lower side of) the main body in the gravity direction.

According to a second example of the present disclosure, an aircraft guidance system is provided to include an aircraft, a survey instrument, and a ground base. The aircraft guidance system performs a lost determination that determines whether the survey instrument fails to maintain tracking of a retroreflective member provided in the aircraft during flight of the aircraft, and defines a lost position when the survey instrument fails to maintain tracking of the retroreflective member. In response to that the lost determination is made, the survey instrument searches a space centering on the lost position for the retroreflective member, while the autonomous flight of the aircraft is stopped at a spot.

### BRIEF DESCRIPTION OF THE DRAWINGS

The objects, features, and advantages of the present disclosure will become more apparent from the following detailed description made with reference to the accompanying drawings. In the drawings:

FIG. 1 is a schematic diagram showing an aircraft guidance system according to a first embodiment;

FIG. 2 is a schematic block diagram showing a configuration of an aircraft in the aircraft guidance system according to the first embodiment;

FIG. 3 is a schematic diagram showing an aircraft in an aircraft guidance system according to a second embodiment;

FIG. 4 is a schematic diagram showing an aircraft in an aircraft guidance system according to the second embodiment;

FIG. 5 is a schematic diagram showing an aircraft in an aircraft guidance system according to the second embodiment;

FIG. 6 is a schematic diagram showing an aircraft in an aircraft guidance system according to the second embodiment;

FIG. 7 is a schematic block diagram showing an aircraft in an aircraft guidance system according to a third embodiment;

FIG. 8 is a schematic diagram showing an aircraft in an aircraft guidance system according to the third embodiment;

FIG. 9 is a schematic diagram showing an aircraft in an aircraft guidance system according to a fourth embodiment;

FIG. 10 is a schematic diagram showing an aircraft in an aircraft guidance system according to the fourth embodiment;

FIG. 11 is a schematic diagram showing an aircraft in an aircraft guidance system according to the fourth embodiment;

FIG. 12 is a schematic diagram showing an aircraft in an aircraft guidance system according to the fourth embodiment;

FIG. 13 is a schematic diagram showing an aircraft in an aircraft guidance system according to a fifth embodiment;

FIG. 14 is a schematic diagram showing an aircraft in an aircraft guidance system according to the fifth embodiment;

FIG. 15 is a schematic diagram showing an aircraft in an aircraft guidance system according to the fifth embodiment;

FIG. 16 is a schematic diagram showing an aircraft in an aircraft guidance system according to a sixth embodiment;

FIG. 17 is a schematic diagram showing an aircraft in an aircraft guidance system according to the sixth embodiment;

FIG. 18 is a schematic diagram showing an aircraft in an aircraft guidance system according to an eighth embodiment;

FIG. 19 is a schematic diagram showing an aircraft guidance system according to a ninth embodiment;

FIG. 20 is a schematic diagram showing an aircraft guidance system according to the ninth embodiment;

FIG. 21 is a schematic block diagram showing an aircraft guidance system according to a tenth embodiment;

FIG. 22 is a schematic diagram showing an aircraft guidance system according to the tenth embodiment;

FIG. 23 is a schematic diagram showing a flowchart of a process by an aircraft guidance system according to the tenth embodiment;

FIG. 24 is a schematic diagram showing a flowchart of a process by an aircraft guidance system according to an eleventh embodiment;

FIG. 25 is a schematic diagram showing a flowchart of a process by an aircraft guidance system according to a twelfth embodiment;

FIG. 26 is a schematic diagram showing a flowchart of a process by an aircraft guidance system according to a modified example of the twelfth embodiment; and

FIG. 27 is a schematic diagram showing a flowchart of a return process by an aircraft guidance system according to the tenth to twelfth embodiments.

### DETAILED DESCRIPTION

Hereinafter, several embodiments of an aircraft guidance system using an aircraft will be described based on the drawings. Elements that are substantially the same in the embodiments are denoted by the same reference signs and will not be described.

### First Embodiment

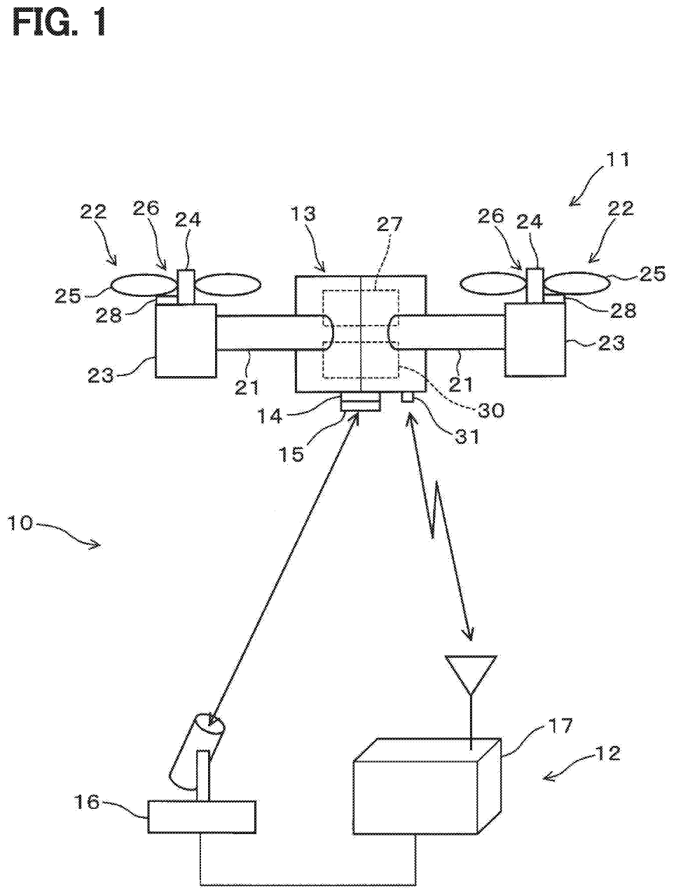

As shown in FIG. 1, an aircraft guidance system 10 according to a first embodiment includes an aircraft 11 and a ground facility 12. The aircraft 11 includes a main body 13, a structure member 14, and a retroreflective member 15. In addition, the ground facility 12 includes a survey instrument 16 and a ground control apparatus 17. The aircraft 11 reflects the light emitted from the survey instrument 16 in the ground facility 12 by using the retroreflective member 15. The survey instrument 16 in the ground facility 12 uses the light reflected by the retroreflective member 15 to track the aircraft 11 to acquire the flight data of the aircraft 11.

The main body 13 of the aircraft 11 includes arms 21 and thrusters 22. The arms 21 are provided so as to individually extend radially from the main body 13; the thrusters 22 are provided at the respective tips of the arms 21. In the main body 13, the arms 21 are not limited to extend radially, but may be configured differently. For instance, the arms 21 may be configured to be an annular shape; a plurality of thrusters 22 are provided in the circumferential direction of the arms 21. Further, the number of arms 21 and thrusters 22 can be set optionally as long as it is two or more.

Each thruster 22 includes a motor 23, a shaft member 24, a propeller 25, and a pitch changing mechanism 26. The motor 23 is a drive source that drives the propeller 25. The motor 23 is driven by electric power supplied from a power source such as a battery 27. The rotation of the motor 23 is transmitted to the propeller 25 through the shaft member 24 integrated with a rotor (not shown). The propeller 25 is rotationally driven by the motor 23. The pitch changing mechanism 26 changes the pitch of the propeller 25 by the driving force generated by a servo motor 28. The servo motor 28 is driven by the electric power supplied from the battery 27. The thruster 22 generates a propulsive force by driving the propeller 25 with the motor 23. In this case, the magnitude and the direction of the propulsive force generated from the thruster 22 are controlled by changing (i) the number of rotations of the motor 23 and (ii) the pitch of the propeller 25.

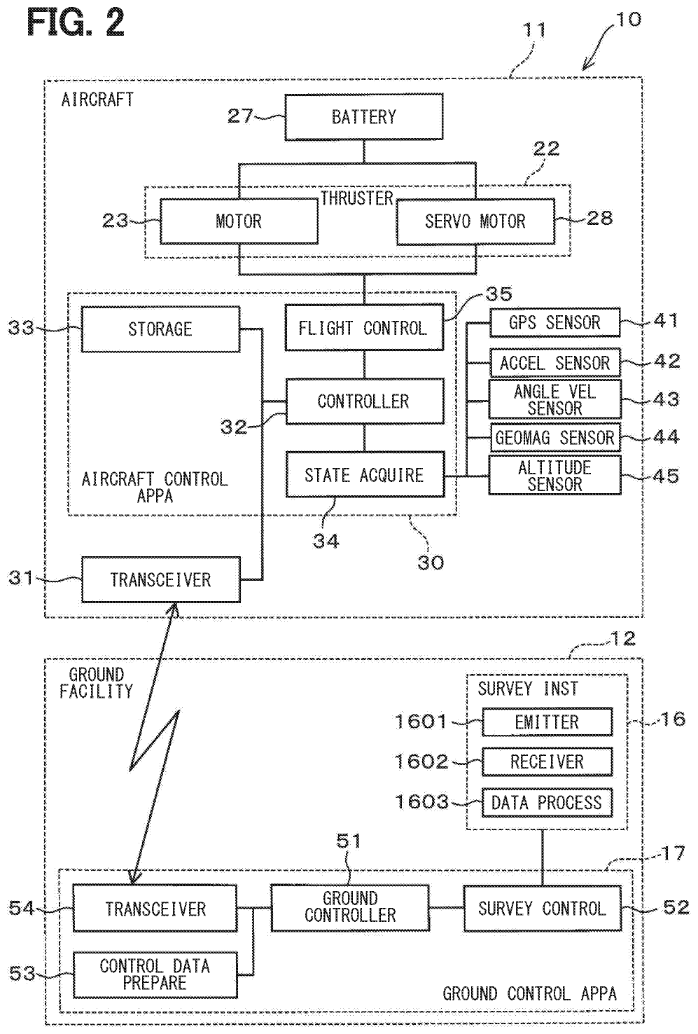

The aircraft 11 includes an aircraft control apparatus 30 and an aircraft transceiver 31. The aircraft control apparatus 30 includes (i) an aircraft controller 32 for controlling the entire aircraft 11 and (ii) a storage 33, as shown in FIG. 2. The aircraft controller 32 is configured by a microcomputer having a CPU, a ROM, and a RAM. The aircraft controller 32 controls the entire aircraft 11 by the CPU executing a computer program stored in the ROM. The aircraft controller 32 implements the flight state acquisition module 34 and the flight control module 35 with software by executing a computer program. The flight state acquisition module 34 and the flight control module 35 are not limited to be implemented in software, and may be implemented in hardware or in cooperation between software and hardware. The storage 33 has, for example, a non-volatile memory. The storage 33 stores a flight plan set in advance as data. The flight plan includes, for example, a flight altitude and a flight route on which the aircraft 11 flies, and the like. The aircraft transceiver 31 communicates with the ground facility 12 via a wireless or wired communication link.

The flight state acquisition module 34 acquires the flight state of the aircraft 11 from the inclination of the main body 13 of the aircraft 11 and the acceleration applied to the main body 13 and the like. Specifically, the flight state acquisition module 34 is connected to the GPS sensor 41, the acceleration sensor 42, the angular velocity sensor 43, the geomagnetic sensor 44, the altitude sensor 45, and the like. The GPS sensor 41 receives a GPS signal output from a GPS satellite. Further, the acceleration sensor 42 detects an acceleration applied to the main body 13 in the three axis directions in three dimensions. The angular velocity sensor 43 detects an angular velocity applied to the main body 13 in three axial directions in three dimensions. The geomagnetic sensor 44 detects a geomagnetism in three axial directions in three dimensions. The altitude sensor 45 detects an altitude in the vertical direction.

The flight state acquisition module 34 detects the flight orientation, flight direction, and flight velocity of the main body 13 from the GPS signals received by the GPS sensor 41, the acceleration detected by the acceleration sensor 42, the angular velocity detected by the angular velocity sensor 43, the geomagnetism detected by the geomagnetic sensor 44. Further, the flight state acquisition module 34 detects the flight position of the main body 13 from the GPS signal detected by the GPS sensor 41 and the detection values of various sensors. Furthermore, the flight state acquisition module 34 detects the flight altitude of the main body 13 from the altitude detected by the altitude sensor 45. Thus, the flight state acquisition module 34 detects information necessary for the flight of the main body 13 as the flight state such as the flight orientation, flight position, and flight altitude of the main body 13. In addition to the above sensors, the flight state acquisition module 34 may be connected to other sensors such as a camera (not shown) that acquires a visible image around the main body 13 or a LIDAR (Light Detection And Ranging) (not shown) that measures the distance to an object around the main body 13.

The flight control module 35 controls the flight of the main body 13 by the autonomous control mode or the remote control mode. The autonomous control mode is a flight mode in which the main body 13 is caused to fly autonomously without the operation of the operator or the guidance from the ground facility 12. In the autonomous control mode, the flight control module 35 automatically controls the flight of the main body 13 of the aircraft 11 in accordance with the flight plan stored in the storage 33. That is, in the autonomous control mode, the flight control module 35 controls the propulsive force of the thrusters 22 based on the flight state of the main body 13 of the aircraft 11 detected by the flight state acquisition module 34. Thereby, the flight control module 35 automatically causes the main body 13 of the aircraft 11 to fly according to the flight plan without need of the operation of the operator or the guidance from the ground facility 12. On the other hand, the remote control mode is a flight mode in which the main body 13 of the aircraft 11 is caused to fly according to the operation of the operator or the guidance from the ground facility 12. In the remote control mode, the ground facility 12 remotely controls the flight state of the main body 13 of the aircraft 11. When the operator operates the flight state of the main body 13 of the aircraft 11, the operator inputs the intention of the operation through the ground facility 12. Further, when guiding the main body 13 of the aircraft 11, the ground facility 12 guides the main body 13 along a preset flight plan. The flight control module 35 controls the propulsive force of the thrusters 22 based on the guidance by the ground facility 12 and the flight state acquired by the flight state acquisition module 34. Thereby, the flight control module 35 causes the main body 13 of the aircraft 11 to fly based on the operation by the operator's intention or the guidance from the ground facility 12.

As shown in FIG. 1, the structure member 14 of the aircraft 11 is provided below the main body 13 in the direction of gravity. That is, the structure member 14 is provided on the lower side of the main body 13 closer to the ground facility 12. The retroreflective member 15 is provided on the structure member 14. The retroreflective member 15 reflects light emitted from the survey instrument 16 of the ground facility 12 toward the survey instrument 16. That is, the retroreflective member 15 reflects the light emitted from the survey instrument 16 toward the survey instrument 16 which is a light source or an emission source. The structure member 14 is not limited to the structure projecting from the main body 13 as in the first embodiment as long as it is provided on the lower side of the main body 13. That is, the structure member 14 may be integrated with the main body 13 or buried in the main body 13.

The ground facility 12 includes the survey instrument 16 and the ground control apparatus 17. As shown in FIG. 2, the ground control apparatus 17 includes a ground controller 51, a survey control module 52, and a control data preparation module 53, and a ground transceiver 54. The ground controller 51 is configured by a microcomputer having a CPU, a ROM, and a RAM. The ground controller 51 controls the entire ground facility 12 by the CPU executing a computer program stored in the ROM. The ground controller 51 implements the survey control module 52 and the control data preparation module 53 with software by executing a computer program. The survey control module 52 and the control data preparation module 53 are not limited to be implemented in software, and may be implemented in hardware or in cooperation between software and hardware.

The survey instrument 16 includes a light emitter 1601, a light receiver 1602, and a data processing module 1603. The light emitter 1601 emits light, such as a laser beam, for example. The light emitter 1601 emits the laser light continuously or periodically at predetermined intervals. The light receiver 1602 receives the light reflected by the retroreflective member 15 provided in the aircraft 11. That is, the light receiver 1602 receives the laser beam emitted from the light emitter 1601 and reflected by the retroreflective member 15 of the aircraft 11.

The survey control module 52 controls the survey instrument 16. Specifically, the survey control module 52 drives the survey instrument 16 in a predetermined direction using, for example, a motor or an actuator (not shown), and causes the survey instrument 16 to track the aircraft 11 flying. At the same time, the survey control module 52 controls the light emitter 1601 to emit light and controls the light receiver 1602 to receive light. As described above, the survey control module 52 controls the emission of light to the aircraft 11 and the reception of light reflected by the aircraft 11 while causing the survey instrument 16 to track the aircraft 11. The data processing module 1603 is implemented by software by causing the ground controller 51 to execute a computer program. The data processing module 1603 is not limited to be implemented in software, and may be implemented in hardware or in cooperation between software and hardware.

The data processing module 1603 acquires flight data of the aircraft 11 from the light received by the light receiver 1602. This flight data includes at least the distance from the ground facility 12 to the aircraft 11 and the angle of the aircraft 11 with respect to the ground facility 12. That is, the data processing module 1603 acquires the distance to the aircraft 11 and the angle of the aircraft 11 from the light received by the light receiver 1602 as flight data. The angle of the aircraft 11 signifies, around the survey instrument 16 in the ground facility 12 as a reference point, an angle in the horizontal direction and an angle in the vertical direction. That is, when the reference point is set in the survey instrument 16, a horizontal angle of 0 to 360 degrees is set in the horizontal direction, and a vertical angle of 0 to 90 degrees is set in the vertical direction. In this case, “0 degree” which is a reference of the horizontal angle is optionally set to “north” in the map coordinates, for example. Further, “0 degree” which is a reference of the vertical angle is set in a plane parallel to the ground, for example. The data processing module 1603 acquires the horizontal angle and the vertical angle of the aircraft 11 from the light received by the light receiver 1602.

The control data preparation module 53 prepares control data for controlling the flight of the aircraft 11. Specifically, the control data preparation module 53 prepares control data based on the flight data acquired by the survey instrument 16. That is, the control data preparation module 53 prepares control data for setting the flight speed, flight position, and flight altitude of the aircraft 11 based on the distance to the aircraft 11 and the angle of the aircraft 11 included in the flight data. The ground transceiver 54 transmits the control data prepared by the control data preparation module 53 to the aircraft 11. That is, the control data prepared by the control data preparation module 53 is transmitted from the ground transceiver 54 to the aircraft transceiver 31 of the aircraft 11. The flight control module 35 of the aircraft 11 thereby receives the control data via the aircraft transceiver 31. The flight control module 35 controls the thrusters 22 based on the control data transmitted from the ground facility 12 and the flight state of the aircraft 11 acquired by the flight state acquisition module 34. As a result, the aircraft 11 flies according to the instruction from the ground facility 12.

In the first embodiment, the retroreflective member 15 that reflects the light emitted from the ground facility 12 to the ground facility 12 is provided in the structure member 14 provided in a lower side of the main body 13 in the gravity direction. The ground facility 12 tracks the flying main body 13 with the light reflected from the retroreflective member 15. Then, the retroreflective member 15 is provided below the main body 13. As a result, the light reflected by the retroreflective member 15 is not obstructed by each part of the main body 13 even if the flight orientation of the main body 13 changes. The reflected light can thereby reach the ground facility 12. In particular, the retroreflective member 15 is provided on the structure member 14 under the main body 13. Thereby, the interference of the main body 13 with the optical path between the retroreflective member 15 and the main body 13 is reduced. That is, for example, the interference between (i) the arm 21 or the rotating propeller 25 and (ii) the optical path is reduced. Therefore, tracking lost can be reduced regardless of the flight orientation of the aircraft 11.

### Second Embodiment

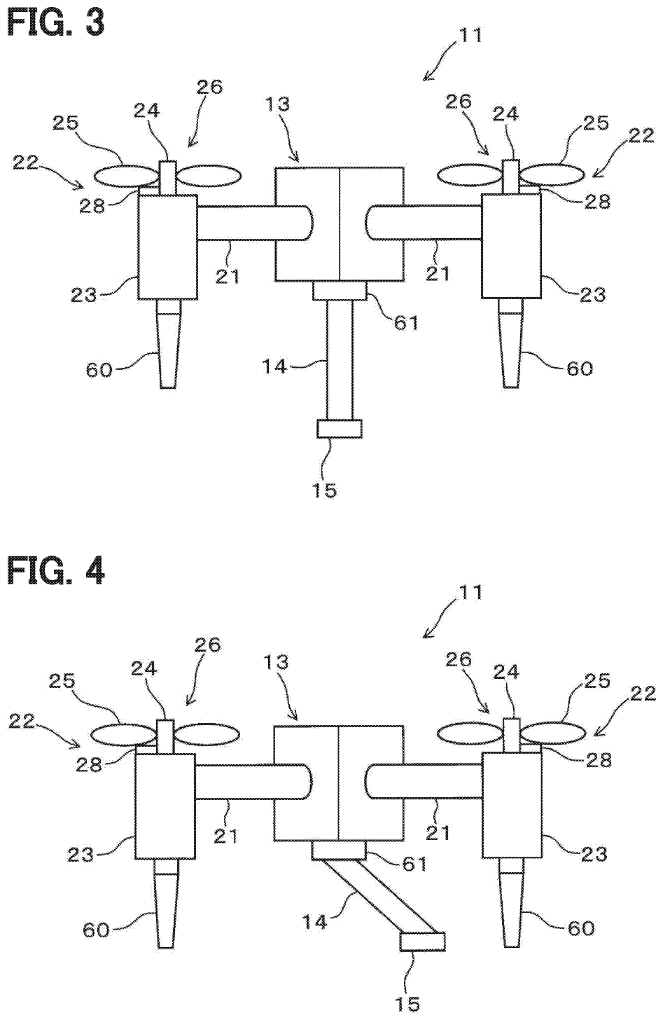

FIG. 3 shows an aircraft used in the aircraft guidance system according to a second embodiment.

The aircraft 11 according to the second embodiment includes support members 60 as an landing gear. In the second embodiment shown in FIG. 3, the support member 60 is provided below the thruster 22. When the aircraft 11 is tracked by the ground facility 12, the retroreflective member 15 provided in the aircraft 11 must be in a position confirmed by the ground facility 12 before takeoff. That is, the retroreflective member 15 must be positioned on the optical path to the survey instrument 16 even before takeoff. Therefore, the aircraft 11 secures a predetermined distance from the ground by the support member 60. In this way, the retroreflective member 15 is exposed below the main body 13 supported by the support member 60 even before takeoff, and facilitates confirmation from the ground facility 12.

In contrast, if the support member 60 is provided, the support member 60 may interfere with the optical path between the ground facility 12 and the retroreflective member 15. That is, depending on the flight orientation of the aircraft 11, the support member 60 may cross the optical path between the ground facility 12 and the retroreflective member 15. As described above, when the support member 60 crosses the optical path, tracking of the aircraft 11 by the ground facility 12 is hindered, which causes tracking lost. Therefore, in the second embodiment, as shown in FIG. 3, the structure member 14 extends below the main body 13, and the tip end of the structure member 14 is located below the support member 60. The retroreflective member 15 is provided at the tip of the structure member 14, that is, the lower end closer to the ground. Thereby, the retroreflective member 15 is provided below the support member 60. As a result, the support member 60 does not interfere with the optical path between the ground facility 12 and the retroreflective member 15 regardless of the flight orientation of the aircraft 11.

On the other hand, if the structure member 14 projects below the support member 60, the retroreflective member 15 and the structure member 14 provided with the retroreflective member 15 may contact or interfere with the ground when the aircraft 11 is landed. Therefore, the aircraft 11 of the second embodiment may include the drive member 61. The drive member 61 drives the structure member 14 to fold the structure member 14 toward the main body 13 as shown in FIG. 4. As a result, the structure member 14 and the retroreflective member 15 provided in the structure member 14 do not project below the support member 60 when the aircraft 11 is landing or taking off.

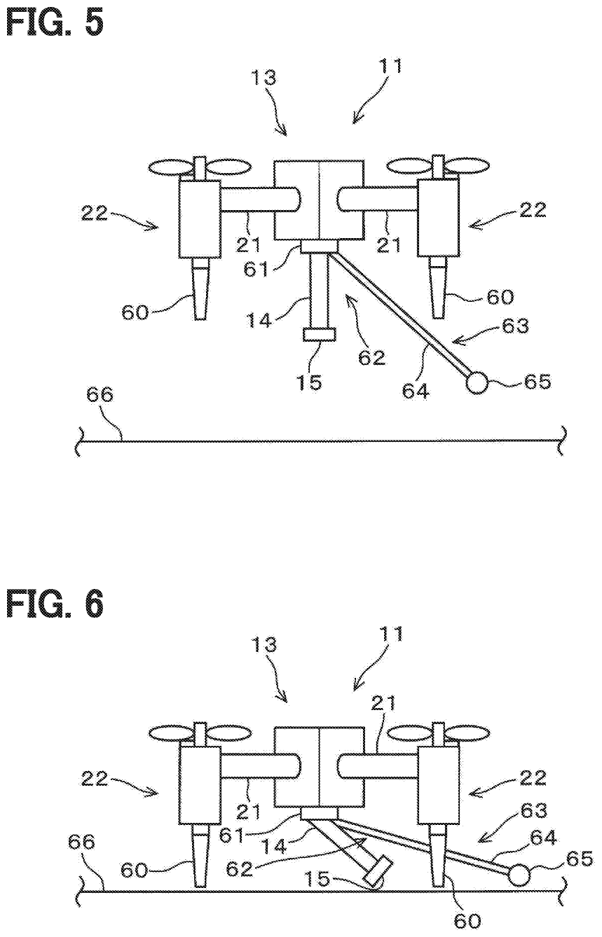

When the structure member 14 is folded in this way, the drive member 61 can be configured to fold the structure member 14 by electric power or hydraulic pressure. Further, the drive member 61 may have a guide member 63 connected to the structure member 14 by a link mechanism 62 as shown in FIGS. 5 and 6. The guide member 63 includes a rod-shaped rod 64 and a roller 65 provided at the tip of the rod 64. The rod 64 is connected to the structure member 14 such that the end portion on the opposite side of the roller 65 can rotate. That is, the structure member 14 and the rod 64 are integrally connected at a predetermined angle. The connecting portion between the structure member 14 and the rod 64 serves as a fulcrum. Then, the structure member 14 and the rod 64 that are integrated with each other rotate around a fulcrum as shown in FIG. 6. As a result, when the aircraft 11 lowers the altitude in landing and the roller 65 provided at the tip of the guide member 63 comes into contact with the ground 66, the roller 65 moves in a direction away from the main body 13. Along with the movement of the roller 65, the rod 64 and the structure member 14, which are integral with each other, rotate about a fulcrum. Therefore, the structure member 14 provided with the retroreflective member 15 is pulled toward the main body 13. As a result, the structure member 14 and the retroreflective member 15 are folded without contacting the ground 66 before the support member 60 of the aircraft 11 contacts the ground 66.

In the second embodiment described above, the retroreflective member 15 is provided at the tip of the structure member 14 projecting from the main body 13, that is, at the lower end closer to the ground 66. Thereby, the retroreflective member 15 is provided below the support member 60. As a result, the support member 60 does not interfere with the optical path between the ground facility 12 and the retroreflective member 15 regardless of the flight orientation of the aircraft 11. Therefore, tracking lost can be reduced regardless of the flight orientation of the aircraft 11.

Further, in the second embodiment, the structure member 14 provided with the retroreflective member 15 is folded toward the main body 13 by the drive member 61. As a result, the structure member 14 and the retroreflective member 15 provided in the structure member 14 do not project below the support member 60 when the aircraft 11 is landing or taking off. Therefore, even when the retroreflective member 15 is provided at the tip of the projecting structure member 14 in order to reduce the tracking loss, it is possible to avoid the interference between (i) the structure member 14 and the retroreflective member 15 and (ii) the ground surface 66, at the time of landing of the aircraft 11.

### Third Embodiment

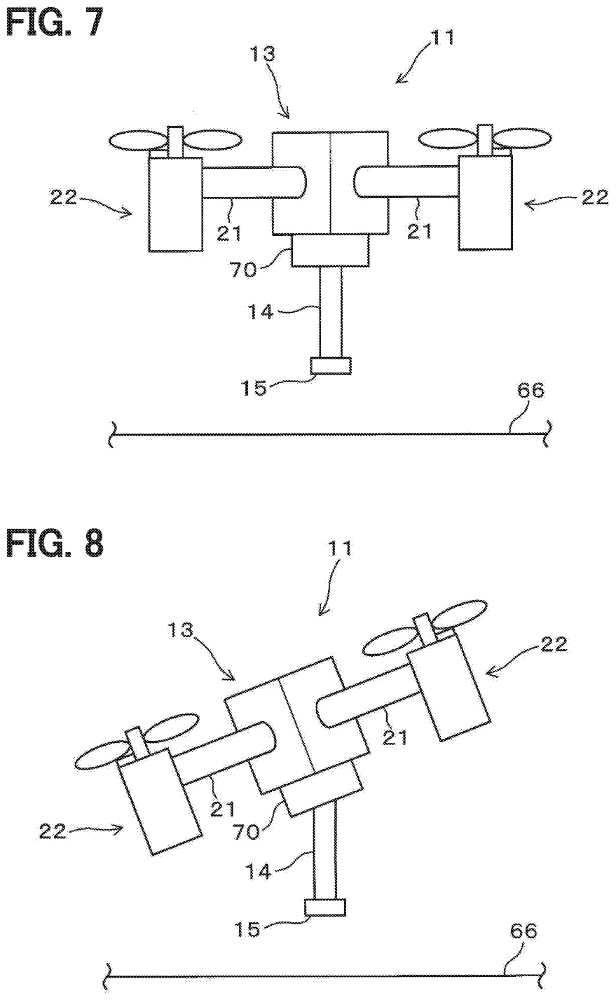

FIGS. 7 and 8 show an aircraft used in the aircraft guidance system according to a third embodiment. As shown in FIGS. 7 and 8, the aircraft 11 according to the third embodiment includes a gimbal 70. The gimbal 70 is provided between the main body 13 and the structure member 14. The gimbal 70 controls the orientation between the main body 13 and the structure member 14. That is, the gimbal 70 keeps the orientation of the structure member 14 with respect to the ground 66 constant. Specifically, the gimbal 70 maintains the structure member 14 provided with the retroreflective member 15 substantially perpendicular to the ground 66. As a result, the retroreflective member 15 provided at the tip of the structure member 14 always has a constant orientation with respect to the ground 66. As a result, even if the flight orientation of the aircraft 11 changes, the change in the orientation of the retroreflective member 15 is small.

In the third embodiment, the gimbal 70 is provided between the main body 13 and the structure member 14. Therefore, the amount of movement of the retroreflective member 15 provided at the tip of the structure member 14 becomes small even if the flight orientation of the aircraft 11 changes. As a result, the ground facility 12 facilitates tracking of the retroreflective member 15 regardless of the flight orientation of the aircraft 11. Therefore, tracking loss can be reduced even when the maneuverability of the aircraft 11 increases.

### Fourth Embodiment

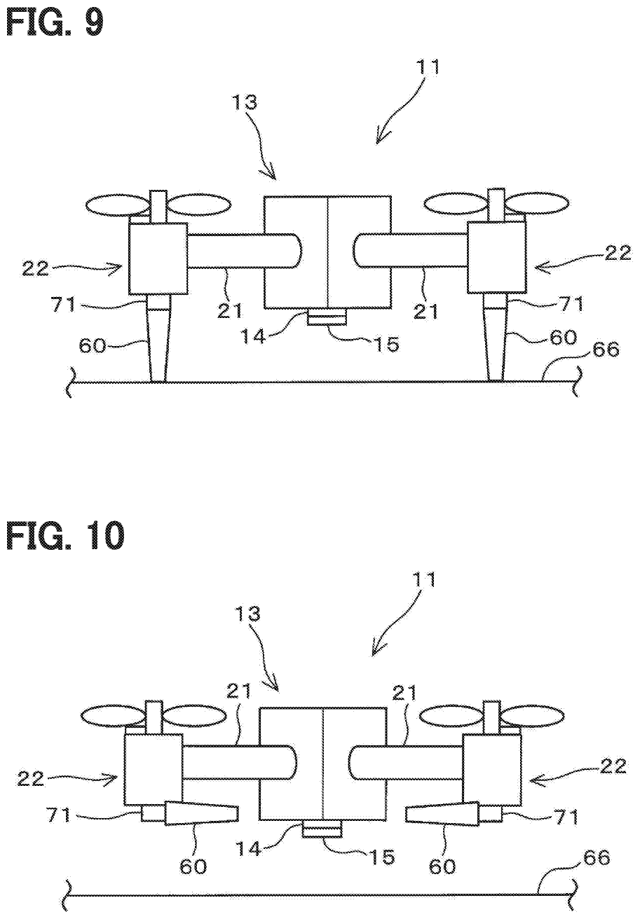

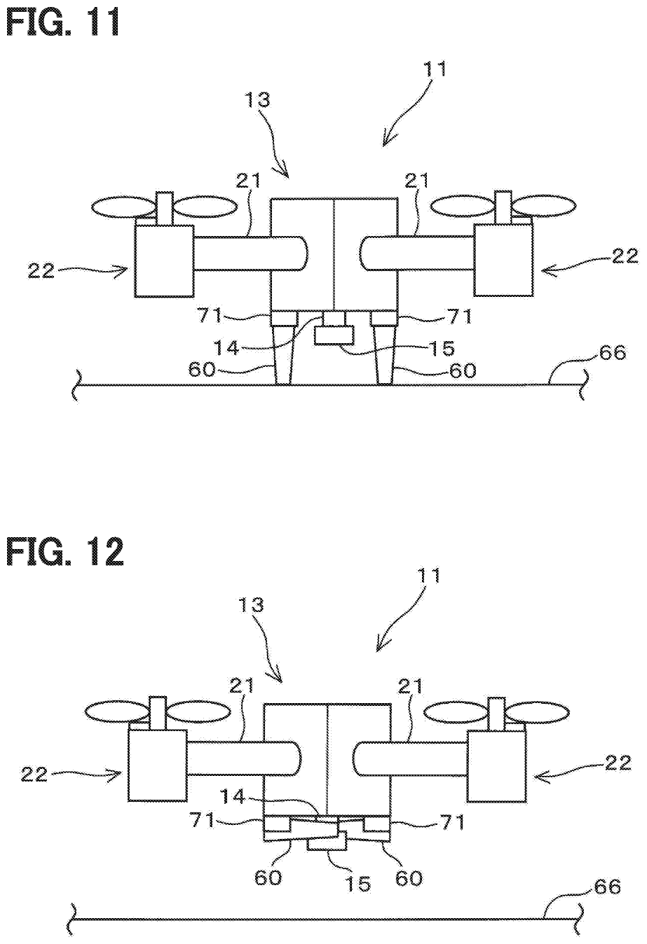

FIGS. 9 to 12 show an aircraft used in the aircraft guidance system according to a fourth embodiment. As shown in FIGS. 9 and 10, the aircraft 11 according to the fourth embodiment includes a support member 60. The support member 60 is provided below the thruster 22. Further, the support member 60 may be provided below the main body 13 as shown in FIGS. 11 and 12. The support member 60 supports the main body 13 with respect to the ground 66 when the aircraft 11 is landing or taking off. In the fourth embodiment, as shown in FIGS. 10 and 12, this support member 60 is foldable. That is, the aircraft 11 according to the fourth embodiment includes a folding mechanism 71 that folds the support member 60.

In this way, by making the support member 60 foldable by the folding mechanism 71, the support part 60 is folded toward the main body 13 after takeoff. As a result, even if the orientation of the aircraft 11 changes after the takeoff, the interference of the support member 60 with the optical path between the ground facility 12 and the retroreflective member 15 is reduced. Therefore, even if the orientation of the aircraft 11 including the support member 60 changes, tracking lost can be reduced.

### Fifth Embodiment

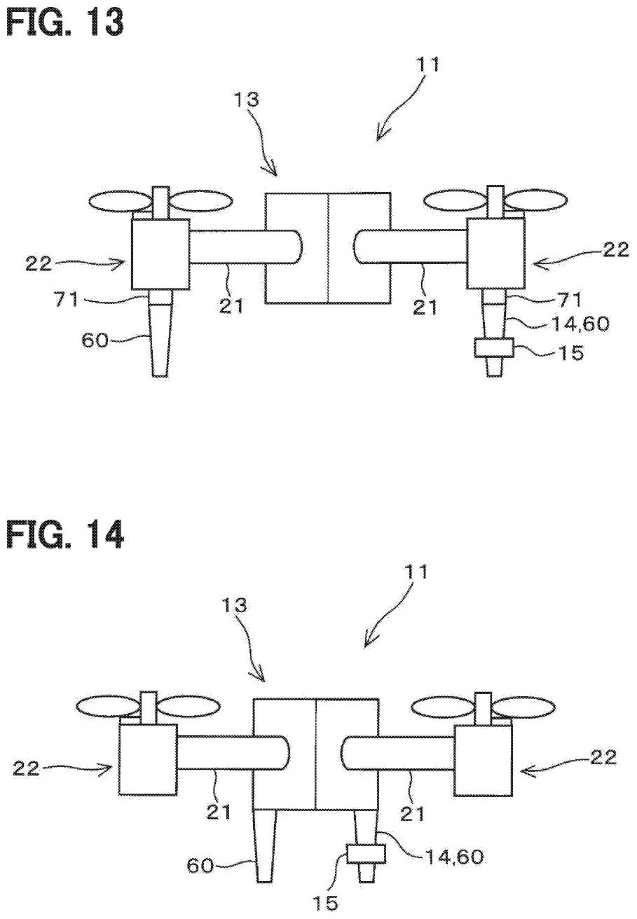

FIGS. 13 and 14 show an aircraft used in the aircraft guidance system according to a fifth embodiment. In the aircraft 11 according to the fifth embodiment, as shown in FIG. 13, the structure member 14 is a support member 60 that supports the main body 13. That is, the structure member 14 functions as a support member 60 that supports the main body 13 on the ground 66 during landing. In the fifth embodiment, the structure member 14 is provided below the thruster 22 as shown in FIG. 13. Further, the structure member 14 may be provided below the main body 13 as shown in FIG. 14. Then, in the fifth embodiment, the retroreflective member 15 is provided in the structure member 14. The retroreflective member 15 is provided on any one of a plurality of structure members 14 as shown in FIGS. 13 and 14.

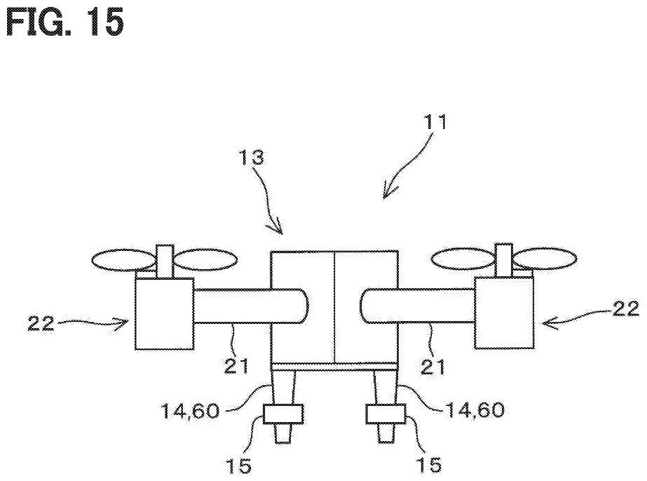

Further, the retroreflective member 15 may be provided in two or more of the structure members 14 among the plurality of structure members 14 as shown in FIG. 15. In this case, the retroreflective member 15 may be provided not only at the lower end but also in the middle in the longitudinal direction of the support member 60 which is the structure member 14. By providing the retroreflective member 15 in the middle in the longitudinal direction of the structure member 14, the ground facility 12 can recognize the retroreflective member 15 of the main body 13 before takeoff. Also in this case, the support member 60 that is the structure member 14 may be provided below the thruster 22.

As described above, in the fifth embodiment, the retroreflective member 15 is provided in the structure member 14 that functions as the support member 60. Therefore, in the retroreflective member 15, the optical path to the ground facility 12 is not blocked by the structure member 14. As a result, the ground facility 12 reliably tracks the retroreflective member 15 even if the flight orientation of the aircraft 11 changes. Therefore, even if the orientation of the aircraft 11 changes, tracking lost can be reduced.

### Sixth Embodiment

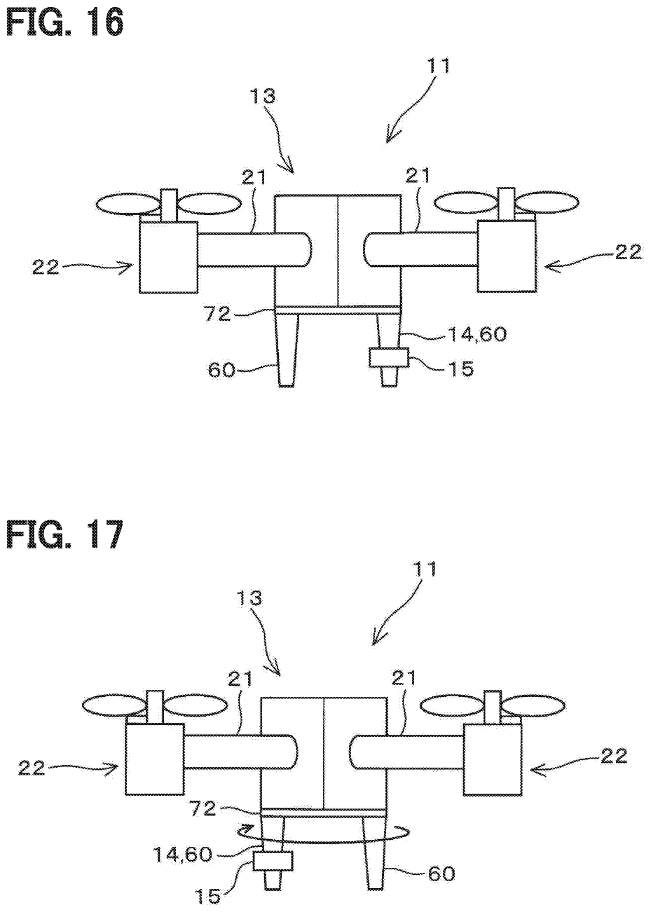

FIGS. 16 and 17 show an aircraft used in the aircraft guidance system according to a sixth embodiment. In the aircraft 11 according to the sixth embodiment, as shown in FIGS. 16 and 17, the aircraft 11 includes a rotary drive member 72 between the main body 13 and the structure member 14. The rotary drive member 72 relatively drives the main body 13 and the structure member 14 about the yaw axis. In the sixth embodiment, the structure member 14 functions as the support member 60 that supports the main body 13 as in the fifth embodiment. The retroreflective member 15 is provided on the structure member 14. The structure member 14 rotates relatively to the main body 13 by the rotary drive member 72. As a result, the retroreflective member 15 provided in the structure member 14 moves to a predetermined position around the yaw axis.

When the aircraft 11 is flying, the structure member 14 is rotated with respect to the main body 13. As a result, the retroreflective member 15 provided in the structure member 14 can be set in a specific orientation regardless of the flight orientation of the aircraft 11. That is, even when the aircraft 11 turns about the yaw axis, the retroreflective member 15 provided in the structure member 14 is maintained in a specific orientation. Specifically, the retroreflective member 15 provided in the structure member 14 remains facing the ground facility 12 even when the aircraft 11 turns around the yaw axis. As a result, even if the aircraft 11 turns, the ground facility 12 can easily catch and track the retroreflective member 15. Therefore, even if the orientation of the aircraft 11 changes, tracking lost can be reduced.

### Seventh Embodiment

An aircraft in an aircraft guidance system according to a seventh embodiment will be described. The seventh embodiment is an embodiment relating to control applicable to any of the above-described first to sixth embodiments as the configuration of the aircraft 11. That is, the seventh embodiment is an embodiment relating to control by the flight control module 35 of the aircraft 11.

In the seventh embodiment, the flight control module 35 controls the flight orientation of the main body 13 so that the retroreflective member 15 faces the ground facility 12. The aircraft 11 causes a complex orientation change centered on the yaw axis, roll axis, and pitch axis during flight. In this case, the flight control module 35 controls the flight orientation of the main body 13 so that the retroreflective member 15 provided in the structure member 14 of the main body 13 faces the ground facility 12. That is, even if the flight orientation of the main body 13 changes due to maneuvering, the flight control module 35 controls the output of the thrusters 22 so that the retroreflective member 15 maintains the orientation toward the ground facility 12. As a result, even if the aircraft 11 turns, the ground facility 12 can easily catch and track the retroreflective member 15. Therefore, even if the orientation of the aircraft 11 changes, tracking lost can be reduced.

### Eighth Embodiment

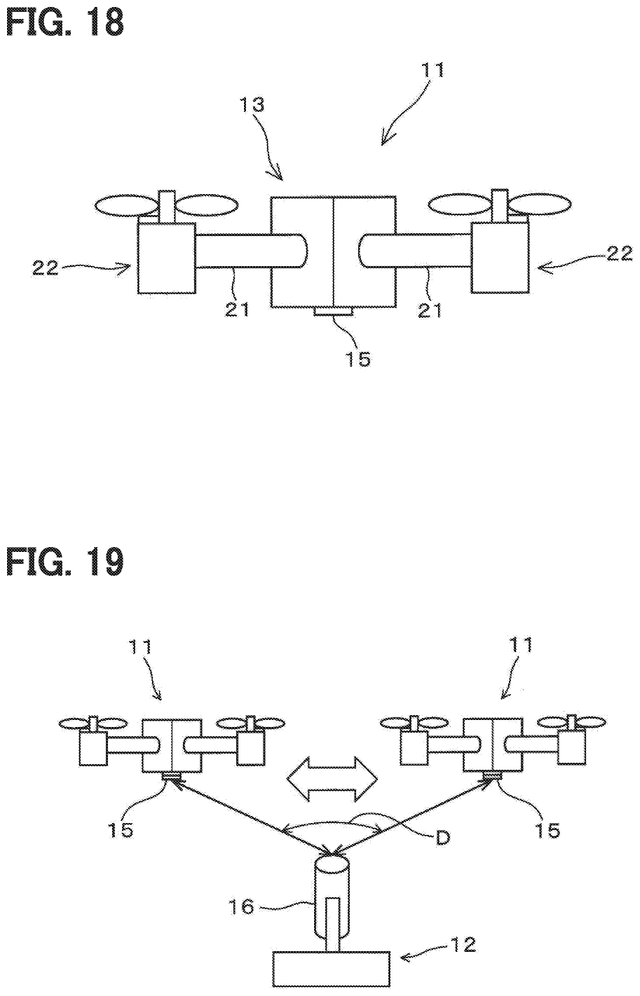

FIG. 18 shows an aircraft used in an aircraft guidance system according to an eighth embodiment. In the eighth embodiment, as shown in FIG. 18, the aircraft 11 includes a main body 13 and a retroreflective member 15. That is, the aircraft 11 of the eighth embodiment does not have a structure corresponding to the structure member 14. In the eighth embodiment, the retroreflective member 15 is provided at the gravity center of the main body 13. The aircraft 11 causes a complex orientation change centered on the yaw axis, roll axis, and pitch axis. At this time, the aircraft 11 has a smaller amount of change in orientation at the gravity center or at a position close to the gravity center as compared with other portions. That is, even when the flight orientation of the aircraft 11 changes, the change amount becomes small at the gravity center or at a position close to the gravity center.

Therefore, in the eighth embodiment, the retroreflective member 15 is provided in the main body 13 at a gravity center or a position close to the gravity center. As a result, even if the flight orientation of the aircraft 11 changes, the change in the position of the retroreflective member 15 is small. As a result, even if the flight orientation of the aircraft 11 changes, the ground facility 12 can easily catch and track the retroreflective member 15. Therefore, even if the orientation of the aircraft 11 changes, tracking lost can be reduced.

### Ninth Embodiment

An aircraft in an aircraft guidance system according to a ninth embodiment will be described. The ninth embodiment is an embodiment relating to control applicable to any of the above-described first to eighth embodiments as the configuration of the aircraft 11. That is, the ninth embodiment is an embodiment relating to control by the flight control module 35 of the aircraft 11.

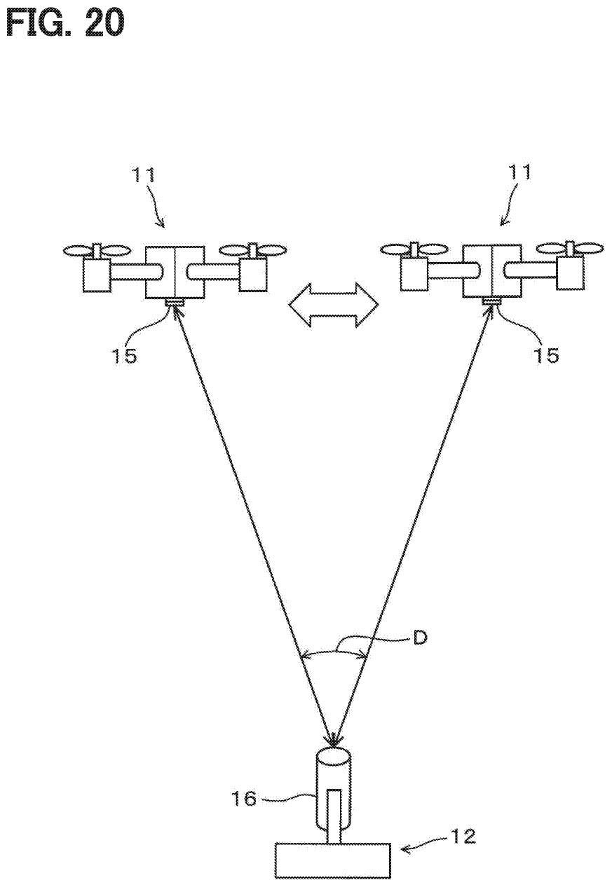

In the ninth embodiment, the flight control module 35 limits at least one of the flight speed of the main body 13 and the acceleration of the main body 13, depending on the distance between the ground facility 12 and the main body 13. As shown in FIG. 19, when the distance between the ground facility 12 and the main body 13 is small, even a slight movement of the main body 13 causes a large amount of change D in the position of the survey instrument 16 that tracks the main body 13. On the other hand, as shown in FIG. 20, as the distance between the ground facility 12 and the main body 13 increases, the amount of change D in the position of the survey instrument 16 that tracks this decreases even if the movement amount of the main body 13 increases. That is, as the distance from the ground facility 12 to the main body 13 becomes smaller, the main body 13 moves faster or abruptly, and the tracking by the survey instrument 16 becomes difficult.

Therefore, in the ninth embodiment, the flight control module 35 limits the maximum value of the flight speed of the main body 13 or the acceleration of the main body 13 when the distance between the ground facility 12 and the main body 13 is small. That is, when the distance from the ground facility 12 to the main body 13 is small, the flight control module 35 reduces the flight speed of the main body 13 and also reduces the acceleration when the main body 13 is moving. In this case, the flight control module 35 may limit either the flight speed or the acceleration, or may limit both the flight speed and the acceleration. The flight control module 35 may continuously set the limit value according to the distance between the ground facility 12 and the main body 13, or set the limit value stepwise in two or more steps according to the distance.

In this way, the flight control module 35 limits the maximum value of the flight speed or the acceleration, so that the flight speed or the acceleration of the aircraft 11 is set within a range in which the ground facility 12 can track. Therefore, even when the distance between the ground facility 12 and the main body 13 is small, the ground facility 12 can easily catch and track the retroreflective member 15. Therefore, tracking loss can be reduced.

### Tenth Embodiment

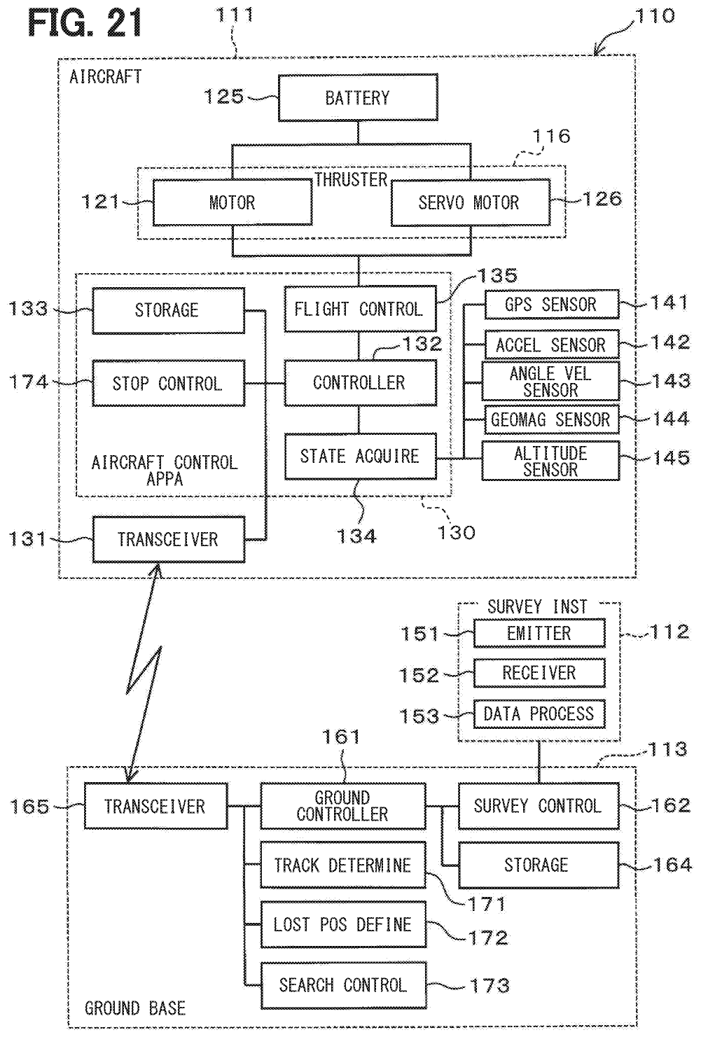

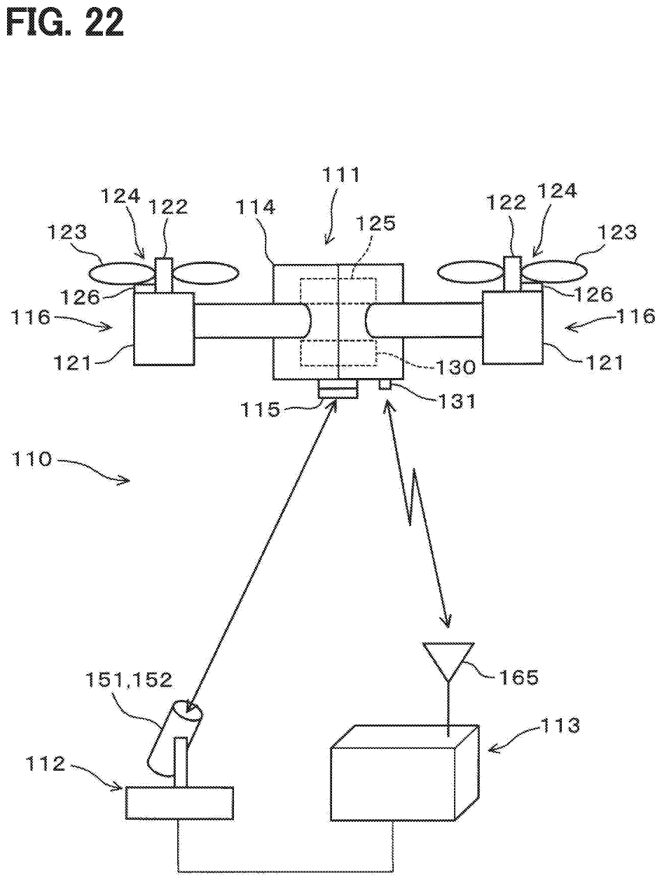

An aircraft guidance system according to a tenth embodiment will be described. As shown in FIGS. 21 and 22, an aircraft guidance system 110 according to the tenth embodiment includes an aircraft 111, a survey instrument 112, and a ground base 113. The aircraft 111 includes a main body 114, a retroreflective member 115, and thrusters 116 as shown in FIG. 22. The aircraft 111 reflects the light emitted from the survey instrument 112 by the retroreflective member 115. The survey instrument 112 tracks the aircraft 111 using the light reflected by the retroreflective member 115 and acquires flight data of the aircraft 111.

The aircraft 111 includes a plurality of thrusters 116 provided on the main body 114. The thrusters 116 are provided on the main body 114 formed in a radial or annular shape. Each thruster 116 has a motor 121, a shaft member 122, a propeller 123, and a pitch changing mechanism 124. The motor 121 is a drive source that drives the propeller 123. The motor 121 is driven by electric power supplied from a power source such as a battery 125 housed in the main body 114. The rotation of the motor 121 is transmitted to the propeller 123 through the shaft member 122 integrated with a rotor (not shown). The propeller 123 is rotationally driven by the motor 121. The pitch changing mechanism 124 changes the pitch of the propeller 123 by the driving force generated by the servo motor 126. The servo motor 126 is driven by the electric power supplied from the battery 125. The thruster 116 generates a propulsive force by driving the propeller 123 with the motor 121. In this case, the magnitude of the propulsive force and the direction of the propulsive force generated from the thruster 116 are controlled by changing the rotation speed of the motor 121 and the pitch of the propeller 123.

The retroreflective member 115 is provided on the main body 114 of the aircraft 111. The retroreflective member 115 is provided at a position easily visible from the survey instrument 112, for example, below the main body 114 in the gravity direction. The retroreflective member 115 reflects the light emitted from the survey instrument 112 toward the survey instrument 112. That is, the retroreflective member 115 reflects the light emitted from the survey instrument 112 toward the survey instrument 112, which is a light source (i.e., an emission source).

The aircraft 111 includes an aircraft control apparatus 130 and a transceiver 131. The aircraft control apparatus 130 includes (i) an aircraft controller 132 for controlling the entire aircraft 111 and (ii) a storage 133, as shown in FIG. 21. The aircraft controller 132 is configured by a microcomputer having a CPU, a ROM and a RAM. The aircraft controller 132 controls the entire aircraft 111 by executing a computer program stored in the ROM by the CPU. The aircraft controller 132 implements the state acquisition module 134 and the flight control module 135 by software by executing a computer program. The state acquisition module 134 and the flight control module 135 are not limited to be implemented in software, and may be implemented in hardware or in cooperation between software and hardware. The storage 133 has, for example, a non-volatile memory. The storage 133 stores a flight plan set in advance as data. The flight plan includes, for example, a flight altitude and a flight route on which the aircraft 111 flies, and the like. The aircraft transceiver 131 communicates with the ground base 113 via a wireless or wired communication link.

The state acquisition module 134 acquires the flight state of the aircraft 111 from the inclination of the main body 114, the acceleration applied to the main body 114, and the like. Specifically, the flight state acquisition module 134 is connected to the GPS sensor 141, the acceleration sensor 142, the angular velocity sensor 143, the geomagnetic sensor 144, the altitude sensor 145, and the like. The GPS sensor 141 receives GPS signals output from GPS satellites. Further, the acceleration sensor 142 detects the acceleration applied to the main body 114 in the three-dimensional three-axis directions. The angular velocity sensor 143 detects the angular velocity applied to the main body 114 in the three-dimensional three-axis directions. The geomagnetic sensor 144 detects geomagnetism in three-dimensional three-axis directions. The altitude sensor 145 detects the altitude in the vertical direction. Among various sensors, the GPS sensor 141 is an external sensor that acquires the position of the aircraft 111 based on information from the external to the aircraft 111. On the other hand, the acceleration sensor 142, the angular velocity sensor 143, the geomagnetic sensor 144, and the altitude sensor 145 are internal sensors that acquire the position of the aircraft 111 without depending on information from the outside of the aircraft 111.

The flight state acquisition module 134 detects the flight orientation, flight direction, and flight velocity of the main body 114 from the GPS signals received by the GPS sensor 141, the acceleration detected by the acceleration sensor 142, the angular velocity detected by the angular velocity sensor 143, the geomagnetism detected by the geomagnetic sensor 144. In addition, the state acquisition module 134 autonomously detects the flight position of the main body 114 from the GPS signal detected by the GPS sensor 141 and the detection values of various sensors without depending on the outside. Furthermore, the state acquisition module 134 detects the flight altitude of the main body 114 from the GPS signal received by the GPS sensor 141 and the altitude detected by the altitude sensor 145. Thus, the flight state acquisition module 134 detects information necessary for the flight of the aircraft 111 as the flight state such as the flight orientation, flight position, and flight altitude of the main body 114. The state acquisition module 134 functions as a position acquisition module that acquires the position of the aircraft 111. In addition to the above sensors, the flight state acquisition module 134 may be connected to other sensors such as a camera (not shown) that acquires a visible image or a LIDAR (Light Detection And Ranging) (not shown) that measures the distance to an object around the main body 114.

The flight control module 135 controls the flight of the aircraft 111 in an automatic control mode or a manual control mode. The flight control module 135 corresponds to a position control module. The automatic control mode is a mode in which the aircraft 111 is automatically flown without need of the operation of the operator. In the automatic control mode, the flight control module 135 automatically controls the flight of the aircraft 111 according to the flight plan stored in the storage 133 or transmitted from the ground base 113. That is, the flight control module 135 controls the propulsive force of the thruster 116 based on the flight state of the main body 114 detected by the state acquisition module 134 in the automatic control mode. As a result, the flight control module 135 causes the aircraft 111 to automatically fly along the flight plan stored in the storage 133 or the flight plan transmitted from the ground base 113, regardless of the operation of the operator.

The manual control mode is a flight mode in which the aircraft 111 is caused to fly according to the operation of the operator. In the manual control mode, the operator controls the flight state of the aircraft 111 through the ground base 113 provided remotely from the aircraft 111. The flight control module 135 controls the propulsive force of the thruster 116 based on the operation input by the operator through the ground base 113 and the flight state acquired by the state acquisition module 134. Accordingly, the flight control module 135 controls the flight of the aircraft 111 according to the intention of the operator.

The survey instrument 112 includes a light emitter 151, a light receiver 152, and a data processing module 153. The light emitter 151 emits light, such as a laser beam, for example. The light emitter 151 emits the laser light continuously or periodically at predetermined intervals. The light receiver 152 receives the light reflected by the retroreflective member 115 provided in the aircraft 111. That is, the light receiver 152 receives the laser beam emitted from the light emitter 151 and reflected by the retroreflective member 115 of the aircraft 111.

The ground base 113 is communicably connected to the survey instrument 112 by wire or wirelessly. The ground base 113 includes a ground controller 161, a survey control module 162, a storage 164, and a ground transceiver 165. The ground base 113 may also be referred to as a ground control apparatus 113. The ground controller 161 is configured by a microcomputer having a CPU, a ROM, and a RAM. The ground controller 161 controls the survey instrument 112 and the ground base 113 by executing a computer program stored in the ROM by the CPU. The ground controller 161 implements the data processing module 153 and the survey control module 162 provided in the survey instrument 112 by software by executing a computer program.

Note that the data processing module 153 and the survey control module 162 are not limited to be implemented in software, and may be implemented in hardware or in cooperation between software and hardware. Further, the survey instrument 112 and the ground base 113 may be configured not only separately as shown in FIG. 22 but also integrally.

The survey control module 162 controls the survey instrument 112. Specifically, the survey control module 162 drives the survey instrument 112 in a predetermined direction using, for example, a motor or an actuator (not shown), and causes the survey instrument 112 to track the aircraft 111 flying. At the same time, the survey control module 162 controls the light emitter 151 to emit light and controls the light receiver 152 to receive light. As described above, the survey control module 162 controls the emission of light to the aircraft 111 and the reception of reflected light while causing the survey instrument 112 to track the aircraft 111. The data processing module 153 acquires flight data of the aircraft 111 from the light received by the light receiver 152. This flight data includes at least the distance from the survey instrument 112 to the aircraft 111 and the angle of the aircraft 111 with respect to the survey instrument 112. That is, the data processing module 153 acquires the distance from the light received by the light receiver 152 to the aircraft 111 and the angle of the aircraft 111 as flight data. Here, the angle of the aircraft 111 is an angle in the horizontal direction and an angle in the vertical direction while centering on the survey instrument 112 as a reference point. That is, when the reference point is set in the survey instrument 112, a horizontal angle of 0 to 360 degrees is set in the horizontal direction, and a vertical angle of 0 to 90 degrees is set in the vertical direction. In this case, “0 degree” which is a reference of the horizontal angle is optionally set to “north” in the map coordinates, for example. Further, “0 degree” which is a reference of the vertical angle is set in a plane parallel to the ground, for example. The data processing module 153 acquires the horizontal angle and the vertical angle of the aircraft 111 from the light received by the light receiver 152. In addition, the data processing module 153 prepares transmission data by including the position coordinates of the aircraft 111 in the above-mentioned flight data. Here, the position where the survey instrument 112 is installed is identified as an absolute position on the earth based on, for example, a GPS signal. The data processing module 153 identifies the position coordinates of the aircraft 111 based on the absolute position of the survey instrument 112 and the flight data acquired by the survey instrument 112. Then, the data processing module 153 prepares transmission data using the flight data and the position coordinates.

As described above, the data processing module 153 prepares the acquired flight data and position coordinates as transmission data. That is, the data processing module 153 prepares transmission data by adding position coordinates to the acquired flight data. The ground transceiver 165 transmits the transmission data prepared by the data processing module 153 to the aircraft 111. In this case, the ground transceiver 165 also transmits the flight plan stored in the storage 164 to the aircraft 111 in addition to the transmission data. That is, the transmission data prepared by the data processing module 153 is transmitted from the ground transceiver 165 to the aircraft transceiver 131 of the aircraft 111. The flight control module 135 of the aircraft 111 that has received the transmission data via the aircraft transceiver 131 controls the thruster 116 with reference to the transmission data transmitted from the ground base 113. Accordingly, the aircraft 111 is autonomously controlled by the flight control module 135 while referring to the flight data acquired at the ground base 113, the flight data including the position coordinates, and the flight plan transmitted from the ground base 113. The storage 164 has, for example, a non-volatile memory. The storage 164 stores a flight plan in which the flight path of the aircraft 111 is set. This flight plan may be the same as or different from the flight plan stored in the storage 133 of the aircraft 111. In addition, by transmitting the flight plan from the ground base 113 to the aircraft 111, the aircraft 111 can perform flexible flight according to the flight plan that is changed at the ground base 113 every moment.

The aircraft guidance system 110 includes a tracking determination module 171, a lost position definition module 172, a search control module 173, and a stop control module 174. Specifically, the aircraft 111 or the ground base 113 executes the computer program in the aircraft controller 132 or the ground controller 161, thereby implementing the tracking determination module 171, the lost position definition module 172, the search control module 173, and the stop control module 174 by software. Note that the tracking determination module 171, the lost position definition module 172, the search control module 173, and the stop control module 174 are not limited to be implemented in software, and may be implemented in hardware or by cooperation between software and hardware. In the tenth embodiment, the tracking determination module 171, the lost position definition module 172, and the search control module 173 are provided in the ground base 113, and the stop control module 174 is provided in the aircraft 111. An individual one of the tracking determination module 171, the lost position definition module 172, the search control module 173, and the stop control module 174 may be provided in either or both of the aircraft 111 and the ground base 113 in any combination, or as a separate device. In other words, the tracking determination module 171, the lost position definition module 172, the search control module 173, and the stop control module 174 may be individually implemented by one or more controllers, which are provided in either or both of the aircraft 111 and the ground base 113 in any combination, or as a separate device.

The tracking determination module 171 determines whether the survey instrument 112 maintains the tracking of the aircraft 111. That is, the tracking determination module 171 performs a lost determination that determines whether the survey instrument 112 maintains the tracking of the aircraft 111. Specifically, it is determined by the tracking determination module 171 whether, when the aircraft 111 is flying, the light is emitted from the light emitter 151 of the survey instrument 112, and the light reflected by the retroreflective member 115 in the aircraft 111 is received by the light receiver 152. The survey instrument 112 is driven through the survey control module 162, and tracks the aircraft 111 using the light, which is emitted from the light emitter 151 and reflected by the retroreflective member 115. That is, the light is emitted from the light emitter 151 of the survey instrument 112 reciprocates between the retroreflective member 115 of the aircraft 111 and the survey instrument 112. In this case, the reciprocation of light between the survey instrument 112 and the aircraft 111 may be hindered by the flight orientation of the aircraft 111 and obstacles existing around the aircraft 111. Thereby, the light receiver 152 cannot receive the light emitted from the light emitter 151. As described above, when the reciprocation of light between the survey instrument 112 and the aircraft 111 is prevented, the survey instrument 112 cannot recognize the aircraft 111 and cannot track the aircraft 111. That is, the survey instrument 112 enters a state of a tracking lost where the aircraft 111 is lost. When the survey instrument 112 cannot recognize the aircraft 111, the tracking determination module 171 determines that tracking lost has occurred and makes “lost determination”.

When the tracking determination module 171 makes the “lost determination”, the lost position definition module 172 defines the position of the aircraft 111 when the “lost determination” is made as the lost position P0. That is, the lost position definition module 172 uses the flight data acquired by the survey instrument 112 to define the flight position of the aircraft 111 when the lost determination is made as the lost position P0. The lost position definition module 172 stores the defined lost position P0 in the storage 164.

When the “lost determination” is made by the lost position definition module 172, the flight control module 135 determines whether the position of the aircraft 111 can be estimated. That is, the flight control module 135 determines whether the flight position of the aircraft 111 can be estimated by the GPS sensor 141. When the aircraft 111 has the GPS sensor 141, the flight position of the aircraft 111 can be estimated by receiving the GPS signal with the GPS sensor 141. Therefore, the flight control module 135 determines that the flight position of the aircraft 111 can be estimated when the GPS sensor 141 can receive the GPS signal. On the other hand, even if the aircraft 111 has the GPS sensor 141, when the GPS signal cannot be received by the GPS sensor 141, it is difficult to estimate the flight position of the aircraft 111. For example, when the aircraft 111 flies inside a structure such as a bridge or a tunnel, it is difficult for the GPS sensor 141 to receive GPS signals. The flight control module 135 determines that the flight position of the aircraft 111 cannot be estimated if the GPS sensor 141 is in a state where it is difficult to receive GPS signals. Further, unlike the present embodiment, the aircraft 111 may not have the GPS sensor 141 in some cases. Thus, when the aircraft 111 does not have the GPS sensor 141, the flight control module 135 determines that the flight position of the aircraft 111 cannot be estimated.

The search control module 173 drives the survey instrument 112 through the survey control module 162. The search control module 173 drives the survey instrument 112 centering on the lost position P0. As a result, the survey instrument 112 searches a space centering on the lost position P0 for the retroreflective member 115 provided in the aircraft 111.

In response to that the lost determination is made, the flight control module 135 stops the flight according to the flight plan set in the aircraft 111. That is, while being controlled according to the flight plan in the automatic control mode, the aircraft 111 stops the flight according to the flight plan in response to that the lost determination is made. Then, the stop control module 174 performs stop control for stopping the aircraft 111 on the spot. That is, the stop control module 174 stops the flight of the aircraft 111 immediately after the lost determination is made, and restricts changes in the flight position and flight altitude of the aircraft 111, such as hovering on the spot. In response to that the flight control module 135 determines that the flight position of the aircraft 111 can be estimated, the stop control module 174 performs stop control based on the GPS signal received by the GPS sensor 141.

On the other hand, in response to that the flight control module 135 determines that it is difficult to estimate the flight position of the aircraft 111, the stop control module 174 performs stop control based on the detection values detected by the acceleration sensor 142, the angular velocity sensor 143, and the geomagnetic sensor 144 provided in the aircraft 111. That is, when it is difficult for the GPS sensor 141 to receive the GPS signal, it is difficult to specify the flight position of the aircraft 111 by the GPS signal. Therefore, the stop control module 174 performs stop control using the acceleration sensor 142, the angular velocity sensor 143, and the geomagnetic sensor 144, which are internal sensors, instead of the GPS sensor 141, which is an external sensor. In this case, the stop control module 174 also controls the altitude of the aircraft 111 using the altitude detected by the altitude sensor 145 both when the GPS sensor 141 can receive the GPS signal and when it is difficult for the GPS sensor 141 to receive the GPS signal. Further, even when the GPS sensor 141 can receive the GPS signal, the stop control module 174 may also estimate the position by using the acceleration sensor 142, the angular velocity sensor 143, and the geomagnetic sensor 144 that are internal sensors, in addition to estimating the position based on the GPS signal.

When the lost determination is made which signifies that the survey instrument 112 fails to track the aircraft 111, it is highly possible that the aircraft 111 exists near the lost position P0. If the aircraft 111 continues to fly even if the lost determination is made, the tracking of the survey instrument 112 becomes more difficult as time passes. Therefore, in response to that the lost determination is made, the stop control module 174 stops the flight of the aircraft 111 and limits the change of the flight position and the flight altitude of the aircraft 111. Then, the search control module 173 uses the survey instrument 112 to search a space centering on the lost position P0 for the retroreflective member 115 provided in the aircraft 111. As a result, the survey instrument 112 searches for the aircraft 111 that is stopped near the lost position P0. It therefore becomes easy to find the aircraft 111 and restart the tracking of the aircraft 111.

The stop control module 174 may be provided in either the aircraft 111 or the ground base 113. That is, the stop control module 174, which is provided in the aircraft 111, autonomously stops the aircraft 111 near the lost position P0 without performing communication with the ground base 113. In contrast, the stop control module 174 may be provided in the ground base 113. In this case, the stop control module 174 stops the aircraft 111 near the lost position P0 by performing communication with the aircraft 111 through the aircraft transceiver 131 and the ground transceiver 165.

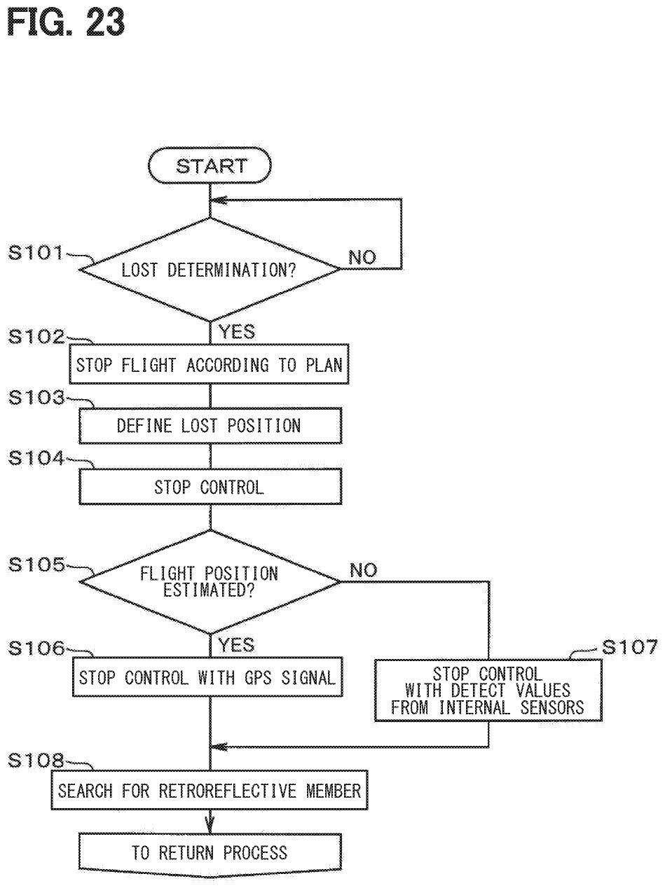

The flowchart of a process in the aircraft guidance system 110 having the above configuration will be described below with reference to FIG. 23.

When the aircraft 111 starts flying, the tracking determination module 171 performs a lost determination (S101). That is, the tracking determination module 171 determines whether the survey instrument 112 fails to maintain the tracking of the aircraft 111, and makes the lost determination if tracking loss occurs. In response to that the tracking determination module 171 makes the lost determination (S101: Yes), the flight control module 135 stops the flight according to the flight plan (S102). That is, in response to that the lost determination is made, the flight control module 135 stops the flight according to the flight plan in the automatic control mode. In response to that the tracking determination module 171 makes the lost determination, the ground transceiver 165 transmits a message to that effect to the aircraft 111. In response to that the flight control module 135 receives, from the ground transceiver 165 via the aircraft transceiver 131, that the lost determination has been made, the flight control module 135 stops the flight according to the flight plan.

The lost position definition module 172 defines the lost position P0 in response to that the flight according to the flight plan is stopped in S102 (S103). That is, the lost position definition module 172 defines the flight position of the aircraft 111 when the lost determination is made as the lost position P0. Then, the stop control module 174 performs stop control for stopping the aircraft 111 at the lost position P0 (S104). That is, in response to that the lost determination is made, the ground transceiver 165 transmits the lost position P0 defined by the lost position definition module 172 to the aircraft 111. The stop control module 174 acquires the lost position P0 from the ground transceiver 165 through the aircraft transceiver 131. In response to that the stop control module 174 receives the lost determination, the stop control module 174 causes the aircraft 111 to shift to the hovering while maintaining the aircraft 111 at the lost position P0. If the lost determination is not made in S101 (S101: No), the tracking determination module 171 repeats the process of S101 until the lost determination is made.

After shifting to the stop control in S104, the flight control module 135 determines whether the flight position of the aircraft 111 can be estimated (S105). That is, the flight control module 135 determines whether the flight position of the aircraft 111 can be estimated by using the GPS signal received by the GPS sensor 141. In response to that it is determined in S105 that the flight position can be estimated (S105: Yes), the stop control module 174 performs control to stop the aircraft 111 at the lost position P0 based on the GPS signal received by the GPS sensor 141 (S106). In this case, the stop control module 174 may control the stop of the aircraft 111 using the detection values of the acceleration sensor 142, the angular velocity sensor 143, and the geomagnetic sensor 144, which are internal sensors, in addition to the GPS signal. On the other hand, in response to that it is determined in S105 that the flight position is difficult to estimate (S105: No), the stop control module 174 controls to stop the aircraft 111 at the lost position P0 (S107) based on the detection values of the acceleration sensor 142, the angular velocity sensor 143, and the geomagnetic sensor 144, which are internal sensors.

While the stop control is being performed in S106 or S107, the search control module 173 drives the survey instrument 112 to search for the retroreflective member 115 (S108). That is, the search control module 173 searches for the retroreflective member 115 provided in the aircraft 111 stopped by the stop control. Accordingly, the search control module 173 searches a space centering on the lost position P0 for the stopped aircraft 111.

In the tenth embodiment described above, the tracking determination module 171 determines whether the survey instrument 112 fails to maintain the tracking of the aircraft 111 during the flight of the aircraft 111. The lost position definition module 172 defines the lost position P0 when the tracking determination module 171 makes a lost determination. Then, in response to that the lost determination is made, the search control module 173 searches a space centering on the lost position P0 for the retroreflective member 115 provided in the aircraft 111. Along with this, the stop control module 174 stops the flight of the aircraft 111 according to the flight plan and causes the aircraft 111 to stop on the spot. As a result, the aircraft 111 is quickly searched for by the survey instrument 112. Therefore, even when tracking lost occurs, it is possible to easily re-track the aircraft 111 by the survey instrument 112.

### Eleventh Embodiment

An aircraft guidance system according to an eleventh embodiment will be described. The aircraft guidance system 110 according to the eleventh embodiment is different from the tenth embodiment in the flowchart of the process by the lost position definition module 172. When the tracking determination module 171 makes a “lost determination”, the lost position definition module 172 of the eleventh embodiment acquires the time at which this “lost determination” was made as time T1. In addition to this, the lost position definition module 172 acquires a period Td from time T1 to time T2 at which the control according to the flight plan is stopped by the flight control module 135. That is, the period Td is Td=T2−T1. The lost position definition module 172 detects time T1 and time T2 based on, for example, a timer (not shown) provided in the ground controller 161, and calculates the period Td. Further, the lost position definition module 172 acquires the flight speed V of the aircraft 111 in the period Td from time T1 to time T2.

The lost position definition module 172 acquires the flight speed V of the aircraft 111 from the flight data acquired by the survey instrument 112 or the detection values of the acceleration sensor 142 and the angular velocity sensor 143 of the aircraft 111. In this case, the lost position definition module 172 may acquire the flight speed V from both the survey instrument 112 and the state acquisition module 134, or may acquire the flight speed V from either one. The lost position definition module 172 calculates the flight position of the aircraft 111 at time T1 when the lost determination is made based on the period Td and the flight speed V. Then, the flight position of the aircraft 111 at this time T1 is defined as the lost position P0.

The aircraft 111 always flies with a change in speed, and the flight position changes from moment to moment due to the influence of disturbance such as airflow. Therefore, it is conceivable that the flight position of the aircraft 111 has moved between the time when the lost determination is made and the time when the flight according to the flight plan is stopped. As a result, even if the flight of the aircraft 111 is stopped by the stop control, the position may be moved from the lost position P0. Therefore, the lost position definition module 172 calculates the flight position of the aircraft 111 at time T1 and defines this as the lost position P0. The stop control module 174 performs stop control of the aircraft 111 based on the lost position P0 defined by the lost position definition module 172.

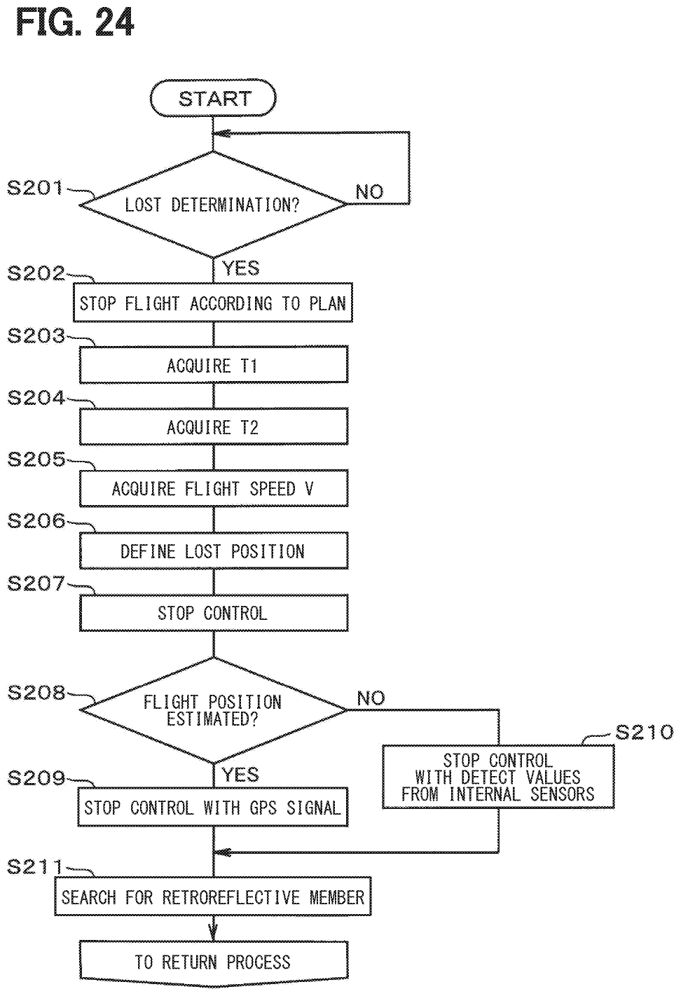

The processing in the aircraft guidance system 110 according to the eleventh embodiment will be described below with reference to FIG. 24. Note that the description of the processing common to the tenth embodiment will be omitted. When the aircraft 111 starts flying, the tracking determination module 171 performs a lost determination (S201). In response to that the tracking determination module 171 makes the lost determination (S201: No), the flight control module 135 stops the flight according to the flight plan (S202).

Then, the lost position definition module 172 acquires the time T1 at which the lost determination is made in S201 (S203). Further, the lost position definition module 172 acquires the time T2 when the flight according to the flight plan is stopped in S202 (S204). Further, the lost position definition module 172 acquires the flight speed V of the aircraft 111 in the period Td from the time T1 acquired in S203 to the time T2 acquired in S204 (S205). The lost position definition module 172 acquires the flight speed V based on the flight data acquired by the survey instrument 112 or the acceleration or angular velocity of the aircraft 111 acquired by the state acquisition module 134. The lost position definition module 172 defines the flight position at the time T1 as the lost position P0 based on the time T1, the time T2, and the flight speed V (S206). The stop control module 174 performs stop control for stopping the aircraft 111 based on the lost position P0 defined in S206 (S207).

In response to that the flight control module 135 shifts to the stop control in S207, the flight control module 135 determines whether the flight position of the aircraft 111 can be estimated (S208). In response to that it is determined that the flight position can be estimated (S208: Yes), the stop control module 174 performs control to stop the aircraft 111 at the lost position P0 based on the GPS signal received by the GPS sensor 141 (S209). On the other hand, in response to that it is determined that the flight position is difficult to estimate (S208: No), the stop control module 174 controls the aircraft 111 to stop at the lost position P0 based on the detection values of the internal sensors (S210). In response to that the stop control is performed in S209 or S210, the search control module 173 drives the survey instrument 112 to search for the retroreflective member 115 (S211). Accordingly, the search control module 173 searches a space centering on the lost position P0 for the stopped aircraft 111.

In the eleventh embodiment, the lost position definition module 172 defines the lost position P0 in consideration of the movement of the aircraft 111 with the passage of time. Along with this, the stop control module 174 returns the aircraft 111 to the lost position P0 in consideration of the movement and then stops the aircraft 111. By continuing the flight, the aircraft 111 may change its position from when the tracking lost occurs to when the lost determination is made and from when the lost determination is made to when the flight according to the flight plan is stopped. Therefore, in response to that the lost determination is made, the stop control module 174 calculates a change in the position of the aircraft 111, returns the aircraft 111, whose position has changed, to the lost position P0, and then stops the aircraft 111. In this way, in response to that the lost determination is made, the aircraft 111 returns to the lost position P0 and stops, and the survey instrument 112 causes the search control module 173 to search a space centering on the lost position P0 for the aircraft 111. As a result, the aircraft 111 is quickly searched for by the survey instrument 112. Therefore, even when the tracking lost occurs, it is possible to easily re-track the aircraft 111 by the survey instrument 112.

### Twelfth Embodiment

An aircraft guidance system according to a twelfth embodiment will be described. The configuration of the aircraft guidance system 110 according to the twelfth embodiment is common to that of the tenth embodiment shown in FIGS. 21 and 22. In the aircraft guidance system 110 according to the twelfth embodiment, in response to that the tracking determination module 171 makes a lost determination, the aircraft transceiver 131 transmits the flight position of the aircraft 111 acquired by the state acquisition module 134 to the survey instrument 112 through the ground base 113. That is, when the tracking determination module 171 makes the lost determination, the state acquisition module 134 acquires the flight position at that time. Then, the aircraft transceiver 131 transmits the flight position acquired by the state acquisition module 134 to the ground base 113. The search control module 173 that drives the survey instrument 112 searches for the retroreflective member 115 of the aircraft 111 with reference to the flight position acquired from the aircraft 111 through the ground base 113. Accordingly, the search control module 173 searches for the retroreflective member 115 with reference to not only the lost position P0 but also the flight position of the aircraft 111 when the lost determination is made. As a result, even when tracking lost occurs, re-tracking of the aircraft 111 by the survey instrument 112 becomes easier.

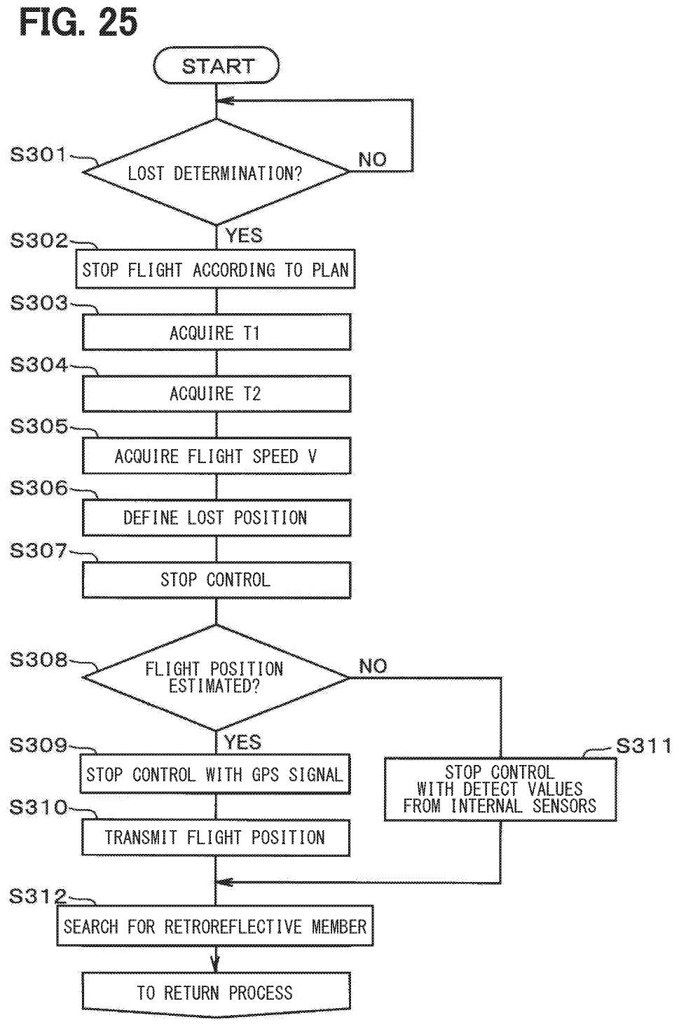

Hereinafter, the flowchart of the process in the aircraft guidance system 110 according to the twelfth embodiment will be described with reference to FIG. 25. Note that the description of the processing common to the eleventh embodiment is omitted. When the aircraft 111 starts flying, the tracking determination module 171 performs a lost determination (S301). In response to that the tracking determination module 171 makes the lost determination (S301: No), the flight control module 135 stops the flight according to the flight plan (S302). Then, the lost position definition module 172 acquires the time T1 at which the lost determination is made in S301 (S303). The lost position definition module 172 also acquires the time T2 when the flight according to the flight plan was stopped in S302 (S304). Further, the lost position definition module 172 acquires the flight speed V of the aircraft 111 in the period Td from the time T1 acquired in S303 to the time T2 acquired in S304 (S305). The lost position definition module 172 defines the flight position at the time T1 as the lost position P0 based on the time T1, the time T2 and the flight speed V (S306). The stop control module 174 performs stop control for stopping the aircraft 111 based on the lost position P0 defined in S306 (S307).

After shifting to the stop control in S307, the flight control module 135 determines whether the flight position of the aircraft 111 can be estimated (S308). In response to that it is determined that the flight position can be estimated (S308: Yes), the stop control module 174 performs control to stop the aircraft 111 at the lost position P0 based on the GPS signal received by the GPS sensor 141 (S309). Then, the aircraft transceiver 131 transmits the flight position of the aircraft 111 based on the GPS signal received by the GPS sensor 141 to the ground base 113 (S310). That is, the state acquisition module 134 acquires the flight position of the aircraft 111 based on the GPS signal received by the GPS sensor 141. The aircraft transceiver 131 transmits the flight position of the aircraft 111 acquired by the state acquisition module 134 to the ground base 113.

On the other hand, in response to that it is determined that the flight position is difficult to estimate (S308: No), the stop control module 174 performs control to stop the aircraft 111 at the lost position P0 based on the detection values of the internal sensors (S311). In response to that the stop control is performed in S309 or S310, the search control module 173 drives the survey instrument 112 to search for the retroreflective member 115 (S311). In this case, the search control module 173 also searches for the retroreflective member 115 by also referring to the flight position of the aircraft 111 transmitted from the aircraft transceiver 131 in S310. As a result, the search control module 173 searches for the stopped aircraft 111 also using the latest flight position centered on the lost position P0.

In the twelfth embodiment, in response to that the tracking determination module 171 determines that the survey instrument 112 fails to maintain the tracking, that is, in response to that the lost determination is made due to tracking lost, the aircraft transceiver 131 transmits the flight position of the aircraft 111 acquired by the state acquisition module 134 to the survey instrument 112 through the ground base 113. Then, in response to that the lost determination is made, the search control module 173 searches, for the retroreflective member 115 provided in the aircraft 111, a space centering on the transmitted flight position of the aircraft 111 in addition to a space centering on the lost position P0. Thus, in response to that the lost determination is made, the aircraft 111 transmits the flight position to the survey instrument 112, and the survey instrument 112 searches, for the aircraft 111, a space centering on the flight position transmitted from the aircraft 111 using the search control module 173. As a result, the aircraft 111 is quickly searched for by the survey instrument 112. Therefore, even when tracking lost occurs, re-tracking of the aircraft 111 by the survey instrument 112 can be facilitated.

### Modified Example of Twelfth Embodiment

In the twelfth embodiment, the example has been described in which the aircraft transceiver 131 transmits the flight position of the aircraft 111 based on the GPS signal acquired by the GPS sensor 141 among the flight positions acquired by the state acquisition module 134. Here, the aircraft transceiver 131 transmits, to the ground base 113, not only the flight position of the aircraft 111 based on the GPS signal but also the flight position based on the detection values of the acceleration sensor 142, the angular velocity sensor 143, and the geomagnetic sensor 144, which are internal sensors.

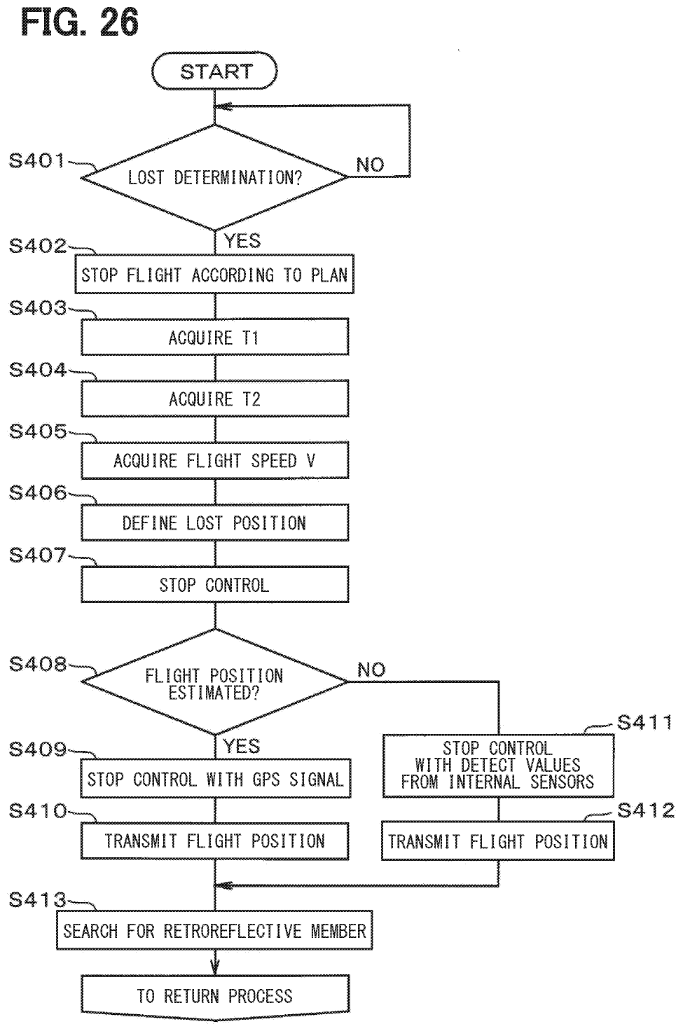

The flowchart of the process in the aircraft guidance system 110 according to the modified example of the twelfth embodiment will be described below with reference to FIG. 26. Note that the description of the processing common to the twelfth embodiment will be omitted. The processing from S401 to S411 is the same as the processing from S301 to S311 in the twelfth embodiment shown in FIG. 25. In the present modified example, when it is determined that the flight position is difficult to estimate (S408: No), the stop control module 174 controls to stop the aircraft 111 at the lost position P0 based on the detection values of the internal sensors (S411). Then, the aircraft transceiver 131 transmits the flight position of the aircraft 111 based on the detection values detected by the internal sensors to the ground base 113 (S412). That is, the state acquisition module 134 acquires the flight position of the aircraft 111 based on the detection values detected by the internal sensors such as the acceleration sensor 142, the angular velocity sensor 143, and the geomagnetic sensor 144. The aircraft transceiver 131 transmits the flight position of the aircraft 111 acquired by the state acquisition module 134 using the internal sensors to the ground base 113.

The search control module 173 drives the survey instrument 112 to search for the retroreflective member 115 while the stop control is performed in S409 or S411 (S413). In this case, the search control module 173 searches for the retroreflective member 115 by also referring to the flight position of the aircraft 111 transmitted from the aircraft transceiver 131 in S410 or S412. As a result, the search control module 173 searches for the stopped aircraft 111 also using the latest flight position centered on the lost position P0. Therefore, even when tracking lost occurs, re-tracking of the aircraft 111 by the survey instrument 112 can be facilitated.

(Return Process from Tracking Lost)

In the tenth to twelfth embodiments described above, a return process from the occurrence of tracking lost to the return of tracking of the aircraft 111 by the survey instrument 112 will be described. This return process is executed after the search for the retroreflective member 115 (S108, S211, S 312, S413) according to the tenth to twelfth embodiments. The return process is executed by a return control module (not shown) provided in the aircraft 111 or the ground base 113. The return control module is implemented by software by executing a computer program by the aircraft controller 132 of the aircraft 111 or the ground controller 161 of the ground base 113. The return control module may be implemented by hardware or by cooperation between software and hardware.

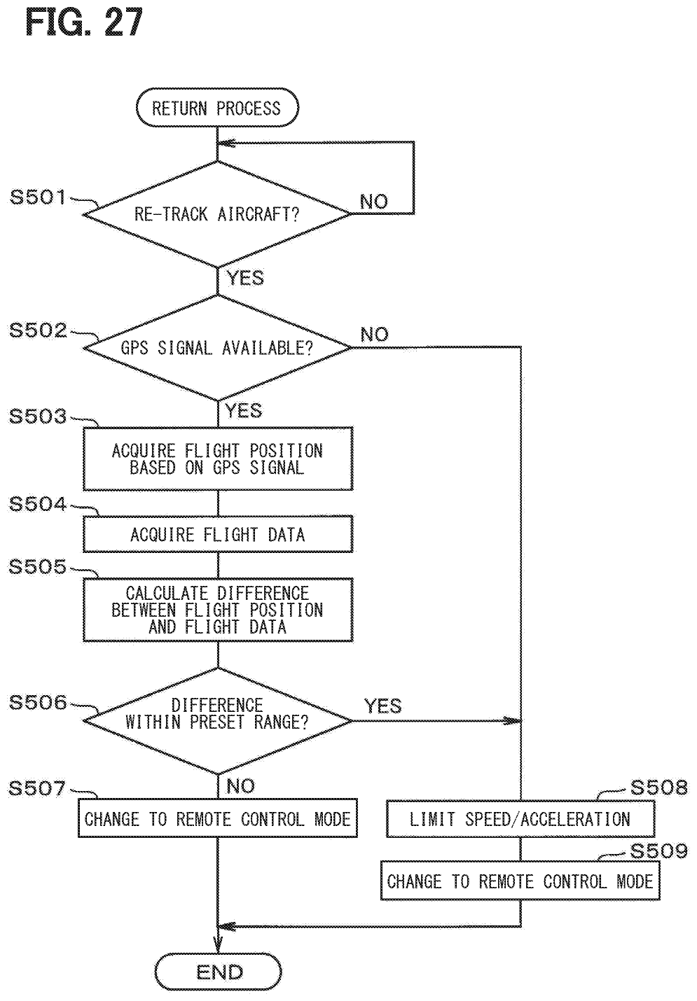

The flowchart of the return process will be described below with reference to FIG. 27. The return control module determines whether the tracking of the aircraft 111 has been restarted (S501). That is, the return control module determines whether the tracking lost of the aircraft 111 by the survey instrument 112 has been eliminated through the tracking determination module 171, and the tracking of the aircraft 111 by the survey instrument 112 has been restarted. When the tracking of the aircraft 111 is restarted (S501: Yes), the return control module determines whether the GPS signal is available (S502). That is, the return control module receives the GPS signal by the GPS sensor 141 and determines whether the flight position of the aircraft 111 can be estimated based on the received GPS signal.

When determining that the GPS signal is available (S502: Yes), the return control module acquires (i) the flight position of the aircraft 111 based on the GPS signal (S503), and (ii) the flight data of the aircraft 111 with the survey instrument 112 (S504). Then, the return control module calculates the difference between the flight data and the flight position based on these GPS signals (S505). That is, the return control module acquires a GPS signal from the state acquisition module 134 of the aircraft 111, and acquires the flight position of the aircraft 111 based on the received GPS signal. At the same time, the return control module acquires flight data by the survey instrument 112 that tracks the aircraft 111. The return control module calculates the difference between the flight position based on these GPS signals and the flight data acquired by the survey instrument 112.

The return control module determines whether the difference calculated in S505 is within a preset setting range (S506). When the return control module determines that the difference is within the preset setting range in S506 (S506: Yes), the return control module changes the control mode of the aircraft 111 to the automatic control mode (S507). That is, when the difference is within the setting range, the return control module determines that the tracking of the aircraft 111 by the survey instrument 112 has returned to the extent that remote control is possible, and changes to the flight in the automatic control mode. As a result, the flight control module 135 of the aircraft 111 shifts to control of the aircraft 111 in the automatic operation mode. As a result, the aircraft 111 flies autonomously by referring to the transmission data from the ground base 113. Here, the setting range can be set according to the performance of the aircraft guidance system 110 including the aircraft 111.

On the other hand, when the return control module determines that the GPS signal cannot be used in S502 (S502: No) or the difference is out of the setting range in S506 (S506: No), the return control module limits the speed and acceleration allowed in the flight of the aircraft 111 (S508). That is, the return control module reduces the maximum values of the speed and the acceleration of the aircraft 111 when the GPS signal is not available or the difference is outside the setting range. In this case, the return control module may reduce only one of the maximum values of the velocity and the acceleration of the aircraft 111, or may reduce both of them. The return control module changes the control mode of the aircraft 111 to the automatic control mode under a state where the maximum values of the speed and the acceleration allowed for the aircraft 111 are reduced in this way (S509). As a result, the flight control module 135 of the aircraft 111 shifts to the control of the aircraft 111 in the automatic control mode with the maximum values of the speed and the acceleration being reduced. As a result, the aircraft 111 flies autonomously under a state where the speed and the acceleration are limited.

When the survey instrument 112 is tracking the aircraft 111, the flight position based on the GPS signal and the flight data acquired by the survey instrument 112 have a match or a small difference. That is, when the survey instrument 112 is tracking the aircraft 111, the aircraft 111 is captured by the survey instrument 112. Therefore, it is considered that there is no large deviation between the flight position based on the GPS signal and the flight data acquired by the survey instrument 112. On the other hand, when the GPS signal cannot be used, even if the survey instrument 112 tracks the aircraft 111, it is not possible to determine whether the flight data grasped by the survey instrument 112 and the actual flight position of the aircraft 111 match. That is, it cannot be determined whether the survey instrument 112 is reliably tracking the aircraft 111. Similarly, when the difference between the flight position and the flight data is out of the setting range, it cannot be determined whether the survey instrument 112 is reliably tracking the aircraft 111. As a result, when the aircraft 111 undergoes a large maneuver, that is, a flight at high speed or a change in flight position at high acceleration, the survey instrument 112 may easily lose sight of the aircraft 111. That is, tracking loss may occur. Therefore, when the return control module cannot use the GPS signal or when the difference between the flight position and the flight data is out of the setting range, the maximum values of the velocity and the acceleration allowed for the aircraft 111 are reduced. As a result, the aircraft 111 does not cause large maneuvers in a short time. Therefore, even if the automatic control mode is entered, the survey instrument 112 can reduce tracking lost.

The present disclosure described above is not limited to the above embodiments, and can be applied to various embodiments without departing from the gist thereof. For example, the above-described embodiments describe the example in which the aircraft 111 includes the GPS sensor 141 that receives the GPS signal. However, the aircraft 111 may not have the GPS sensor 141. In this case, the aircraft 111 cannot use the GPS sensor 141, which is an external sensor. From this, the stop control module 174 can perform stop control using the acceleration sensor 142, the angular velocity sensor 143, and the geomagnetic sensor 144, which are internal sensors, as described in the embodiments.

Although the present disclosure has been made in accordance with the embodiments, it is understood that the present disclosure is not limited to such embodiments and configurations. The present disclosure covers various modified examples and equivalent arrangements. In addition, various combinations and forms, and further, other combinations and forms including only one element, or more or less than these elements are also within the scope and the scope of the present disclosure.

The aircraft controller 32, the aircraft controller 132, the ground controller 51, and the ground controller 161 are described in the above embodiments. Such controllers can provide a plurality of functions and may implement a plurality of modules. An individual module can provide one or more functions among the plurality of functions by the controllers. Each of the controllers and the techniques thereof according to the present disclosure may be implemented by one or more special-purposed computers. Such a special-purposed computer may be provided (i) by configuring (a) a processor and a memory programmed to execute one or more functions embodied by a computer program, or (ii) by configuring (b) a processor including one or more dedicated hardware logic circuits, or (iii) by configuring by a combination of (a) a processor and a memory programmed to execute one or more functions embodied by a computer program and (b) a processor including one or more dedicated hardware logic circuits. The computer programs may be stored, as instructions to be executed by a computer, in a tangible non-transitory computer-readable medium.

For reference to further explain features of the present disclosure, the description is added as follows.

An aircraft so-called drone has recently become widespread. The aircraft flies mainly by wireless or wired remote control by a ground operator. When remotely controlling the aircraft in this manner, it is necessary to synchronously acquire the current position of the aircraft. Information on obstacles existing around the aircraft is acquired, and a safe flight range in which safe flight of the aircraft is ensured is set based on the acquired information. Then, the ground facility implements the guidance of the aircraft while tracking the aircraft flying in the safe flight range.

However, when the aircraft is tracked by the ground facility in this way, so-called tracking loss may occur in which the ground facility loses sight of the aircraft depending on the flight orientation of the aircraft. When the tracking lost occurs, the aircraft may not receive guidance from the ground facility, and the flight of the aircraft may become unstable.

Therefore, it is thus desired to provide an aircraft and an aircraft guidance system that reduce tracking lost regardless of the flight orientation. In addition, it is also desired to provide an aircraft guidance system that facilitates re-tracking of an aircraft by a survey instrument even when tracking lost occurs.

Aspects of the present disclosure described herein are set forth in the following clauses.

According to a first aspect of the present disclosure, an aircraft is provided to include a main body, a structure member, and a retroreflective member.

In the configuration according to the first aspect, the retroreflective member reflects the light emitted from the ground facility to the ground facility. The retroreflective member is provided in the structure member provided below (i.e., in a lower side of) the main body in the gravity direction. The ground facility tracks the flying main body with the light reflected from the retroreflective member. By providing the retroreflective member below the main body, the light reflected by the retroreflective member reaches the ground facility without being obstructed by the main body even if the flight orientation of the main body changes. In particular, providing the retroreflective member in the structure member below the main body reduces the interference of the main body with the optical path between the retroreflective member and the main body. Therefore, tracking lost can be reduced regardless of the flight orientation of the aircraft.

According to a second aspect of the present disclosure, an aircraft guidance system is provided to include an aircraft, a survey instrument, and a ground base. The aircraft guidance system further includes a tracking determination module, a lost position definition module, a search control module, and a stop control module.

In the second aspect of the present disclosure, the tracking determination module performs a lost determination that determines whether the survey instrument fails to maintain tracking of the retroreflective member during flight of the aircraft. The lost position definition module defines the lost position when the survey instrument fails to maintain tracking of the retroreflective member, that is, when the lost determination is made by the tracking determination module due to the tracking lost. The lost position is a flight position of the aircraft when the lost determination is made. Then, in response to that the lost determination is made, the search control module searches a space centering on the lost position for the retroreflective member provided in the aircraft. Along with this, the stop control module stops the autonomous flight of the aircraft at a spot and stops the aircraft at the spot. Here, stopping the aircraft means a state in which the position and altitude are not changed while continuing flight. In this way, in response to that the lost determination is made, the aircraft stops at the spot, and the survey instrument searches a space centering on the lost position for the aircraft by the search control module. As a result, the aircraft is quickly searched for by the survey instrument. Therefore, even when tracking lost occurs, it is possible to easily re-track the aircraft by the survey instrument.

According to a third aspect of the present disclosure, an aircraft guidance system is provided to include an aircraft, a survey instrument, and a ground base. The aircraft guidance system further includes a tracking determination module, a lost position definition module, a search control module, and a stop control module.

In the third aspect of the present disclosure, the tracking determination module performs a lost determination that determines whether the survey instrument fails to maintain the tracking of the retroreflective member during flight of the aircraft. The lost position definition module defines the lost position when the survey instrument fails to maintain tracking of the retroreflective member, that is, when the lost determination is made by the tracking determination module due to the tracking lost. The lost position is a flight position of the aircraft when the lost determination is made. Then, in response to that the lost determination is made, the search control module searches a space centering on the lost position for the retroreflective member provided in the aircraft. Along with this, the stop control module returns the aircraft to the lost position in consideration of the movement and stops the aircraft. By continuing the flight, the aircraft may change its position between the time when the tracking lost occurs and the time when the lost determination is made. Therefore, in response to that the lost determination is made, the stop control module returns the aircraft whose position has changed to the lost position and stops the aircraft. Here, stopping the aircraft means a state in which the position and altitude are not changed while continuing flight. In this way, in response to that the lost determination is made, the aircraft returns to the lost position and stops; the survey instrument searches a space centered on the lost position for the aircraft with the search control module. As a result, the aircraft is quickly searched for by the survey instrument. Therefore, even when tracking lost occurs, it is possible to easily re-track the aircraft by the survey instrument.

According to a fourth aspect of the present disclosure, an aircraft guidance system is provided to include an aircraft, a survey instrument, and a ground base. The aircraft guidance system further includes a tracking determination module and a search control module. The aircraft guidance system yet further includes a position acquisition module and an aircraft transceiver in the aircraft.

In the fourth aspect of the present disclosure, the tracking determination module performs a lost determination that determines whether the survey instrument fails to maintain tracking of the retroreflective member during flight of the aircraft. The aircraft transceiver transmits the flight position of the aircraft acquired by the position acquisition module to the survey instrument in response to that the survey instrument fails to maintain tracking of the retroreflective member, that is, in response to that the lost determination is made due to tracking lost. The flight position is a flight position of the aircraft when the lost determination is made. Then, in response to that the lost determination is made, the search control module searches a space centering on the transmitted flight position for the retroreflective member provided in the aircraft. In this way, in response to that the lost determination is made, the aircraft transmits the flight position to the survey instrument. At the same time, the survey instrument searches a space centering on the flight position transmitted from the aircraft for the aircraft in addition to the lost position, by the search control module. As a result, the aircraft is quickly searched for by the survey instrument. Therefore, even when tracking lost occurs, it is possible to easily re-track the aircraft by the survey instrument.

Further, in the above aspects, the modules may be implemented individually by one or more controllers included in the aircraft guidance system.

What is claimed is:

1. An aircraft comprising:
a main body;
a support member configured to support the main body on a ground during landing;
a structure member provided on a lower side of the main body in a gravity direction to project to a side opposite to the main body from the support member; and
a retroreflective member provided in the structure member to reflect a light, which is emitted from a ground facility, toward the ground facility,
wherein:
the structure member is enabled to be folded toward the main body.

2. The aircraft according to claim 1, further comprising:
a drive member configured to fold the structure member toward the main body.

3. The aircraft according to claim 1, further comprising:
a gimbal provided between the main body and the structure member
to maintain an orientation of the structure member with respect to the gravity direction and
to maintain the structure member perpendicular to the ground.

4. The aircraft according to claim 1, further comprising:
a controller configured to control a flight orientation of the main body to cause the retroreflective member to face the ground facility.

5. The aircraft according to claim 1, wherein:
the retroreflective member is movable toward the ground facility in the main body or the structure member.

6. An aircraft comprising:
a main body;
a structure member connected to the main body;
a support member configured to support the main body on a ground during landing;
a retroreflective member provided in the structure member to reflect a light, which is emitted from a ground facility, toward the ground facility; and
a folding mechanism configured to fold the support member toward the main body.

7. An aircraft comprising:
a main body; and
a retroreflective member provided at a gravity center of the main body during flight to reflect a light, which is emitted from a ground facility, toward the ground facility.

8. An aircraft comprising:
a main body;
a retroreflective member provided in the main body to reflect a light, which is emitted from a ground facility, toward the ground facility; and
a controller configured to limit at least one of a flight speed of the main body and an acceleration of the main body according to a distance between the main body and the ground facility.

9. An aircraft guidance system comprising:
the aircraft according to claim 1 and a ground facility,
the ground facility comprising:
a survey instrument configured to acquire flight data of the aircraft by tracking the aircraft from a light reflected from the retroreflective member provided in the aircraft;
a control data preparation module configured to prepare control data to control a flight of the aircraft based on the flight data acquired by the survey instrument; and
a ground transceiver configured to transmit the prepared control data to the aircraft.

10. The aircraft guidance system according to claim 9, wherein:
the ground facility further comprises a controller connected with the survey instrument and the ground transceiver, the controller being configured to implement the control data preparation module.

11. An aircraft guidance system comprising:
an aircraft including a retroreflective member configured to reflect a light to an emission source;
a survey instrument configured to emit a light to the aircraft,
to track the aircraft from a light reflected by the retroreflective member, and
to acquire as flight data a flight angle of the aircraft and a distance to the aircraft; and
a ground base configured to control the aircraft based on the flight data acquired by the survey instrument,
wherein
the aircraft guidance system further comprises:
a tracking determination module configured to perform a lost determination that determines whether the survey instrument fails to maintain tracking of the retroreflective member during flight of the aircraft based on only the flight data acquired by the survey instrument;
a lost position definition module configured to define, in response to the lost determination being made, a flight position of the aircraft when the lost determination is made as a lost position;
a search control module configured to drive the survey instrument in response to the lost determination being made to search a space centering on the lost position for the retroreflective member; and
a stop control module configured to control the aircraft in response to the lost determination being made so as to cause the aircraft (i) to stop movement along with the flight of the aircraft, (ii) to stop and (iii) to remain at a spot where the aircraft stops.

12. An aircraft guidance system comprising:
an aircraft including a retroreflective member configured to reflect a light to an emission source;
a survey instrument configured to emit a light to the aircraft, to track the aircraft from a light reflected by the retroreflective member, and to acquire as flight data a flight angle of the aircraft and a distance to the aircraft; and
a ground base configured to control the aircraft based on the flight data acquired by the survey instrument,
wherein the aircraft guidance system further comprises:
a tracking determination module configured to perform a lost determination that determines whether the survey instrument fails to maintain tracking of the retroreflective member during flight of the aircraft based on only the flight data acquired by the survey instrument;
a lost position definition module configured to define, in response to the lost determination being made, a flight position of the aircraft when the lost determination is made as a lost position;
a search control module configured to drive the survey instrument in response to the lost determination being made to search a space centering on the lost position for the retroreflective member; and
a stop control module configured to control the aircraft in response to the lost determination being made so as to cause the aircraft (i) to stop movement along with the flight, (ii) to return to the lost position and (ii) to stop.

13. The aircraft guidance system according to claim 11, further comprising:
a position acquisition module provided in the aircraft to autonomously acquire a flight position of the aircraft; and
a position control module provided in the aircraft to control flight based on the acquired flight position in response to the lost determination being made.

14. An aircraft guidance system comprising:
an aircraft including a retroreflective member configured to reflect a light to an emission source;
a survey instrument configured to emit a light to the aircraft, to track the aircraft from a light reflected by the retroreflective member, and to acquire as flight data a flight angle of the aircraft and a distance to the aircraft; and
a ground base configured to control the aircraft based on the flight data acquired by the survey instrument,
wherein the aircraft is further includes an aircraft transceiver,
wherein the aircraft guidance system further comprises:
a position acquisition module provided in the aircraft to autonomously acquire a flight position of the aircraft;
a tracking determination module configured to perform a lost determination that determines whether the survey instrument fails to maintain tracking of the retroreflective member during flight of the aircraft based on only the flight data acquired by the survey instrument, wherein in response to the lost determination being made, the flight position autonomously acquired by the position acquisition module in the aircraft is transmitted via the aircraft transceiver to the survey instrument; and
a search control module configured to drive the survey instrument to search, for the retroreflective member, a space centering on the flight position transmitted from the aircraft to the survey instrument via the aircraft transceiver.

15. The aircraft guidance system according to claim 14, further comprising:
a flight control module provided in the aircraft to continue flight of the aircraft based on the flight position autonomously acquired by the position acquisition module in the aircraft in response to the lost determination being made.

16. The aircraft guidance system according to claim 11, further comprising:
one or more controllers configured to implement the tracking determination module, the lost position definition module, the search control module, and the stop control module.

17. The aircraft guidance system according to claim 12, further comprising:
one or more controllers configured to implement the tracking determination module, the lost position definition module, the search control module, and the stop control module.

18. The aircraft guidance system according to claim 13, further comprising:
one or more controllers including at least one controller provided in the aircraft,
the at least one controller being configured to implement the position acquisition module and the position control module.

19. The aircraft guidance system according to claim 14, further comprising:
one or more controllers configured to implement the tracking determination module and the search control module,
wherein the one or more controllers includes at least one controller provided in the aircraft, the at least one controller being configured to implement the position acquisition module.

20. The aircraft guidance system according to claim 15, further comprising: one or more controllers including at least one controller provided in the aircraft, the at least one controller being configured to implement the flight control module.
